(19) United States
(12) Patent Application Publication
(10) Pub. No.: US 2021/0207009 A1
(43) Pub. Date: Jul. 8, 2021

(54) ADHESIVE COMPOSITION AND USE THEREOF

(71) Applicant: TOAGOSEI CO., LTD., Tokyo (JP)

(72) Inventors: Nobuyuki Takeya, Aichi (JP); Kenichi Nakamura, Aichi (JP); Yusuke Hashimoto, Aichi (JP)

(73) Assignee: TOAGOSEI CO., LTD., Tokyo (JP)

(21) Appl. No.: 17/205,348

(22) Filed: Mar. 18, 2021

Related U.S. Application Data
(63) Continuation of application No. PCT/JP2019/035951, filed on Sep. 12, 2019.

(30) Foreign Application Priority Data
Sep. 19, 2018 (JP) 2018-174576

(51) Int. Cl. C09J 133/08; C09J 7/38; B32B 5/26; B32B 7/12; A41H 43/04

(52) U.S. Cl. CPC C09J 133/08; C09J 7/385; B32B 2437/00; B32B 7/12; A41H 43/04; B32B 5/26

(57) ABSTRACT

This adhesive composition for bonding fiber fabrics contains a vinyl polymer (A) and an acrylic adhesive polymer (B). The vinyl polymer (A) has a glass transition temperature Tg_{A} of 30° C. to 200° C. inclusive and a number average molecular weight of 500 to 10,000 inclusive. The adhesive composition has a glass transition temperature Tg₁ of −80° C. to 10° C. inclusive. The storage elastic modulus of an adhesive layer formed using the adhesive composition is 1.0 MPa or less at 23° C.

### CROSS-REFERENCE TO RELATED APPLICATIONS

This application claims priority from Japanese Patent Application No. 2018-174576 filed on Sep. 19, 2018, the entirety of which is incorporated herein by reference.

### BACKGROUND

### Technical Field

The present disclosure relates to an adhesive composition for bonding fiber fabrics, more particularly, to an adhesive composition for use in bonding various fiber fabrics, and to an adhesive sheet and an article of clothing using the adhesive composition.

### Description of the Related Art

In one method of producing clothing products, fiber fabrics are bonded together through a bonding process, instead of sewing by means of a sewing machine or the like. The clothes produced through such a bonding process have no seam or stitch in the fabrics, and such products have attracted attention in recent years as clothes of good design. In the case of cold-proof clothes such as down jackets, seams resulting from sewing may cause drawbacks. Specifically, such seams release warm air from inside the jackets, and leak some down through the seams. Also, the cold air outside may enter the jackets. As an advantage, clothes produced through a bonding process can prevent the aforementioned drawbacks resulting from sewing.

There have been disclosed various methods for bonding fabrics through a bonding process. Japanese Patent Application Laid-Open (kokai) No. 2016-74996 and Japanese Patent Application Laid-Open (kokai) No. 2017-78232 disclose a method for bonding clothes or fabrics by use of a urethane-based hot-melt adhesive. Japanese Patent Application Laid-Open (kokai) No. 2002-338908 discloses textile products obtained through heat fusion bonding, wherein an acrylic or urethane resin or a heat-adhesive tape partially provided with an adhesive material (e.g., silicone or urethane synthetic rubber) is inserted between fiber fabrics.

### SUMMARY

The present specification provides the following means.

[1] An adhesive composition for bonding fiber fabrics, the composition comprising a vinyl polymer (A) and an acrylic adhesive polymer (B), wherein

the vinyl polymer (A) has a glass transition temperature Tg_{A} of 30° C. to 200° C. inclusive and a number average molecular weight of 500 to 10,000 inclusive; and

the adhesive composition for bonding fiber fabrics has a glass transition temperature Tg₁ of −80° C. to 10° C. inclusive, and an adhesive layer formed from the adhesive composition for bonding fiber fabrics exhibits a storage elastic modulus of 1.0 MPa or less at 23° C.

[2] The adhesive composition for bonding fiber fabrics of the aforementioned [1], wherein a surface portion of the adhesive layer which has been formed on a separator by use of the adhesive composition for bonding fiber fabrics has a glass transition temperature Tg₂ which is higher, by 30° C. or more, than the glass transition temperature Tg₁ of the adhesive composition for bonding fiber fabrics, wherein the glass transition temperature Tg₂ is calculated from the composition of the surface portion of the adhesive layer through X-ray photoelectron spectroscopy.

[3] The adhesive composition for bonding fiber fabrics of the aforementioned [1] or [2], wherein the vinyl polymer (A) has structural units derived from an alicyclic vinyl monomer in an amount of 10 mass % or more, with respect to the entire (i.e., total) monomer units forming the vinyl polymer (A).

[4] The adhesive composition for bonding fiber fabrics of any one of the aforementioned [1] to [3], wherein the amount of the vinyl polymer (A) is 0.5 parts by mass to 60 parts by mass inclusive, with respect to 100 parts by mass of the acrylic adhesive polymer (B).

[5] An adhesive sheet comprising a separator, and an adhesive layer formed on the separator by use of the adhesive composition for bonding fiber fabrics as recited in any one of the aforementioned [1] to [4].

[6] An article of clothing, which article has a bonding portion where fiber fabrics are bonded together by the mediation of an adhesive layer (i.e., bonded to each other through an adhesive layer) formed by use of the adhesive composition for bonding fiber fabrics as recited in any one of the aforementioned [1] to [4].

### DETAILED DESCRIPTION

Hereinafter, the disclosure of the present specification will be described in detail. As used herein, the term “(meth)acrylic” refers to acrylic and/or methacrylic. The term “(meth)acrylate” refers to acrylate and/or methacrylate. The term “(meth)acryloyl group” refers to acryloyl group and/or methacryloyl group.

The adhesive composition according to the present disclosure for bonding fiber fabrics (hereinafter, the composition may be referred to simply as an “adhesive composition”) contains a vinyl polymer (A) and an acrylic adhesive polymer (B). Hereinafter, the vinyl polymer (A), the acrylic adhesive polymer (B), and the adhesive composition containing the polymers will be described in detail.

The hot-melt adhesive disclosed in Japanese Patent Application Laid-Open (kokai) No. 2016-74996 loses flexibility at room temperature and becomes solid. Therefore, the bonding portion hardens, thereby impairing touch feeling and comfort. In addition, the resulting bonding strength is insufficient. According to the method of Japanese Patent Application Laid-Open (kokai) No. 2017-78232, bonding strength is improved. However, there are some concerns with the method, which include complicated steps, and insufficient texture and like properties. The method of Japanese Patent Application Laid-Open (kokai) No. 2002-338908 provides insufficient bonding strength. When tensile stress is applied to the bonding portion, the portion may be broken in a peeling manner.

Thus, one or more embodiments of the present disclosure provide an adhesive composition for bonding fiber fabrics which can provide high bonding strength between the fiber fabrics and can also provide a bonding portion having softness and excellent texture. One or more embodiments also provide an adhesive sheet and an article of clothing using the adhesive composition.

In view of the foregoing, the present inventors have conducted extensive studies, and have focused on an adhesive composition containing a low-molecular-weight vinyl polymer a and an acrylic adhesive polymer. Specifically, the inventors have found that, by forming an adhesive layer from an adhesive composition which contains a vinyl polymer having a molecular weight falling within a specific range and an acrylic adhesive polymer, and adjusting the storage elastic modulus of the adhesive layer at room temperature to fall within a specific range, if the adhesive composition is used for bonding various fiber fabrics as a novel use, the fiber fabrics can be bonded to each other at high bonding strength, and the bonded portion is endowed with softness and excellent texture.

Thus, using the adhesive composition of the present disclosure, various fiber fabrics can be bonded together at high bonding strength while softness of the raw fiber fabrics is maintained. When fiber fabrics are bonded together by the mediation of an adhesive layer formed from the adhesive composition of the present disclosure, high peel strength and high tensile shear strength can be attained, whereby the bonding portion is resistant to stress (e.g., peeling) applied thereto, and the fabrics can be strongly bonded. In addition, the adhesive composition of the present disclosure can impart high bonding strength to difficult-to-bond fiber fabrics which have received a special treatment (e.g., waterproofing). Further, since the bonding portion has high softness and excellent texture, the bonded fabric product can be suitably used as a seamless garment or the like.

In the present specification, the glass transition temperatures (Tg) will be described in the following manner. The glass transition temperature of the vinyl polymer (A) is described as a “glass transition temperature Tg_{A},” and the glass transition temperature of the acrylic adhesive polymer (B) is described as a “glass transition temperature Tg_{B}.” Also, the glass transition temperature of the adhesive composition for bonding fiber fabrics is described as a “first glass transition temperature Tg₁.” The first glass transition temperature Tg₁ is a glass transition temperature of the adhesive composition containing the vinyl polymer (A), the acrylic adhesive polymer (B), and other optionally added ingredients. In the present specification, the glass transition temperature Tg_{A}, the glass transition temperature Tg_{B}, and the first glass transition temperature Tg₁ are measurements obtained through differential scanning calorimetry (DSC) at a temperature elevation rate of 10° C./min.

In the present specification, the glass transition temperature of a surface portion of the adhesive layer which has been formed on a separator by use of the adhesive composition for bonding fiber fabrics is described as a “second glass transition temperature Tg_{2.}” The second glass transition temperature Tg₂ is calculated from the compositional ratio of vinyl polymer (A) to acrylic adhesive polymer (B) determined through X-ray photoelectron spectrometry (XPS).

The aforementioned peeling strength, tensile shear strength, storage elastic modulus, and texture can be measured through the methods described in the Examples in the present specification.

### [Vinyl Polymer (A)]

The vinyl polymer (A) is a polymer having a glass transition temperature (Tg_{A}) of 30° C. to 200° C. inclusive. The glass transition temperature Tg_{A} is preferably 40° C. or higher, more preferably 50° C. or higher. The glass transition temperature Tg_{A} is still more preferably 60° C. or higher, yet more preferably 70° C. or higher, further more preferably 80° C. or higher. Also, the glass transition temperature Tg_{A} is preferably 180° C. or lower, more preferably 150° C. or lower, still more preferably 120° C. or lower, yet more preferably 110° C. or lower, further more preferably 100° C. or lower. The glass transition temperature Tg_{A} is more preferably 50° C. to 180° C. inclusive, still more preferably 60° C. to 150° C. inclusive. When the glass transition temperature Tg_{A} is excessively low, difficulty is encountered in attaining sufficiently high glass transition temperature Tg₂ of the surface portion of the adhesive layer, in the case where the adhesive layer is formed from the adhesive composition. In this case, bonding strength to a fiber fabric or the like may be poor, resulting in low durability. From the viewpoint of limitation on selection of the raw material monomers or the like, the glass transition temperature Tg_{A} is generally 200° C. or lower.

As a monomer which forms the vinyl polymer (A), a variety of radically polymerizable vinyl unsaturated compounds. Examples of such vinyl unsaturated compounds include a hydrocarbyl (meth)acrylate ester compound, an aromatic vinyl compound, an unsaturated carboxylic acid, an unsaturated acid anhydride, a hydroxyl group-containing unsaturated compound, an amino group-containing unsaturated compound, an amido group-containing unsaturated compound, an alkoxy group-containing unsaturated compound, a cyano group-containing unsaturated compound, a nitrile group-containing unsaturated compound, and a maleimide compound. These compounds may be used singly or in combination of two or more species.

Examples of the hydrocarbyl (meth)acrylate ester compound include such as alkyl (meth)acrylate esters such as methyl (meth)acrylate, ethyl (meth)acrylate, n-propyl (meth)acrylate, isopropyl (meth)acrylate, n-butyl (meth) acrylate, isobutyl (meth) acrylate, tert-butyl (meth)acrylate, amyl (meth)acrylate, n-hexyl (meth)acrylate, n-octyl (meth)acrylate, ethylhexyl (meth)acrylate, n-dodecyl (meth)acrylate, and n-octadecyl (meth)acrylate; alicyclic (meth)acrylate ester compounds (hereinafter may be referred to as an “alicyclic vinyl monomers”) such as cyclohexyl (meth) acrylate, methylcyclohexyl (meth) acrylate, tert-butylcyclohexyl (meth) acrylate, cyclododecyl (meth) acrylate, isobornyl (meth) acrylate, adamantyl (meth) acrylate, dicyclopentenyl (meth) acrylate, and dicyclopentanyl (meth)acrylate; and aromatic (meth)acrylate ester compounds (hereinafter may be referred to as an “aromatic vinyl monomers”) such as phenyl (meth)acrylate and benzyl (meth)acrylate. These compounds may be used singly or in combination of two or more species.

No particular limitation is imposed on the amount of hydrocarbyl (meth)acrylate ester compound when used. When a hydrocarbyl (meth)acrylate ester compound is used, the amount of structural units derived from hydrocarbyl (meth)acrylate ester compound, with respect to the amount of the entire monomer units forming the vinyl polymer (A), is preferably 10 mass % or more, more preferably 30 mass % or more, still more preferably 50 mass % or more. No particular limitation is imposed on the upper limit of the amount of structural units derived from hydrocarbyl (meth)acrylate ester compound, and the amount may be adjusted to 100 mass % or less.

Examples of the aromatic vinyl compound include styrene, α-methylstyrene, o-methylstyrene, p-methylstyrene, vinyltoluene, β-methylstyrene, ethylstyrene, p-tert-butylstyrene, vinylxylene, and vinylnaphthalene. These compounds may be used singly or in combination of two or more species. When an aromatic vinyl compound is used in the production of the vinyl polymer (A), the specific amount of the aromatic vinyl compound used is preferably 1 mass % to 50 mass % inclusive, more preferably 5 mass % to 40 mass % inclusive, with respect to the amount of the entire monomer units forming the vinyl polymer (A).

Examples of the unsaturated carboxylic acid include (meth)acrylic acid, ethacrylic acid, maleic acid, fumaric acid, itaconic acid, crotonic acid, citraconic acid, cinnamic acid, and unsaturated dicarboxylate monoalkyl esters (e.g., monoalkyl esters of maleic acid, fumaric acid, itaconic acid, citraconic acid, maleic anhydride, itaconic anhydride, citraconic anhydride, or the like). These compounds may be used singly or in combination of two or more species.

Examples of the unsaturated acid anhydride include maleic anhydride, itaconic anhydride, and citraconic anhydride. These compounds may be used singly or in combination of two or more species.

Examples of the hydroxyl group-containing unsaturated compound include hydroxyalkyl (meth)acrylates such as 2-hydroxyethyl (meth)acrylate, 2-hydroxypropyl (meth)acrylate, 3-hydroxypropyl (meth)acrylate, 2-hydroxybutyl (meth)acrylate, 3-hydroxybutyl (meth)acrylate, and 4-hydroxybutyl (meth)acrylate; polyalkylene glycol mono(meth)acrylate esters such as polyethylene glycol and polypropylene glycol; and p-hydroxystyrene, m-hydroxystyrene, o-hydroxystyrene, p-isopropenylphenol, m-isopropenylphenol, and o-isopropenylphenol. These compounds may be used singly or in combination of two or more species.

Examples of the amino group-containing unsaturated compound include dimethylaminomethyl (meth) acrylate, diethylaminomethyl (meth) acrylate, 2-dimethylaminoethyl (meth)acrylate, 2-diethylaminoethyl (meth)acrylate, 2-(di-n-propylamino) ethyl (meth) acrylate, 2-dimethylaminopropyl (meth)acrylate, 2-diethylaminopropyl (meth)acrylate, 2-(di-n-propylamino) propyl (meth) acrylate, 3-dimethylaminopropyl (meth)acrylate, 3-diethylaminopropyl (meth)acrylate, and 3-(di-n-propylamino) propyl (meth)acrylate. These compounds may be used singly or in combination of two or more species.

Examples of the amido group-containing unsaturated compound include (meth)acrylamide, N,N-dimethyl(meth)acrylamide, N,N-dimethylaminopropyl(meth)acrylamide, and N-methylol(meth)acrylamide. These compounds may be used singly or in combination of two or more species.

Examples of the alkoxy group-containing unsaturated compound include 2-methoxyethyl (meth)acrylate, 2-ethoxyethyl (meth)acrylate, 2-(n-propoxy)ethyl (meth)acrylate, 2-(n-butoxy)ethyl (meth)acrylate, 3-methoxypropyl (meth)acrylate, 3-ethoxypropyl (meth)acrylate, 2-(n-propoxy)propyl (meth)acrylate, and 2-(n-butoxy)propyl (meth)acrylate. These compounds may be used singly or in combination of two or more species.

Examples of the cyano group-containing unsaturated compound include cyanomethyl (meth)acrylate, 1-cyanoethyl (meth)acrylate, 2-cyanoethyl (meth)acrylate, 1-cyanopropyl (meth)acrylate, 2-cyanopropyl (meth)acrylate, 3-cyanopropyl (meth) acrylate, 4-cyanobutyl (meth) acrylate, 6-cyanohexyl (meth)acrylate, 2-ethyl-6-cyanohexyl (meth)acrylate, and 8-cyanooctyl (meth)acrylate. These compounds may be used singly or in combination of two or more species.

Examples of the nitrile group-containing unsaturated compound include (meth)acrylonitrile, ethacrylonitrile, α-ethylacrylonitrile, α-isopropylacrylonitrile, α-chloroacrylonitrile, and α-fluoroacrylonitrile. These compounds may be used singly or in combination of two or more species.

Examples of the maleimide compound include maleimide, N-methylmaleimide, N-isopropylmaleimide, N-butylmaleimide, N-dodecylmaleimide, N-cyclohexylmaleimide, N-phenylmaleimide, N-(2-methylphenyl)maleimide, N-(4-methylphenyl)maleimide, N-(2, 6-dimethylphenyl)maleimide, N-(2,6-diethylphenyl)maleimide, N-benzylmaleimide, and N-naphtylmaleimide. These compounds may be used singly or in combination of two or more species.

Other than the aforementioned compounds, a dialkyl unsaturated dicarboxylate ester, a vinyl ester compound, a vinyl ether compound, etc. may also be used. Examples of the dialkyl unsaturated dicarboxylate ester include dialkyl esters of an unsaturated dicarboxylic acid such as maleic acid, fumaric acid, itaconic acid, citraconic acid, maleic anhydride, itaconic anhydride, or citraconic anhydride. Examples of the vinyl ester compound include methylene aliphatic monocarboxylate esters, vinyl acetate, vinyl propionate, vinyl pivalate, vinyl butyrate, vinyl benzoate, vinyl formate, and vinyl cinnamate. Examples of the vinyl ether compound include vinyl methyl ether, vinyl ethyl ether, vinyl n-butyl ether, vinyl isobutyl ether, vinyl phenyl ether, and vinyl cyclohexyl ether.

Among these compounds, the vinyl polymer (A) is preferably formed mainly of a hydrocarbyl (meth)acrylate ester compound, from the viewpoint of attaining appropriate compatibility with the acrylic adhesive polymer (B). In the vinyl polymer (A), the specific amount of structural units derived from the hydrocarbyl (meth)acrylate ester compound is preferably 10 mass % to 100 mass % inclusive, with respect to the amount of the entire monomer units forming the vinyl polymer (A). The amount of structural units derived from the hydrocarbyl (meth)acrylate ester compound is more preferably 30 mass % or more, still more preferably 50 mass % or more, with respect to the amount of the entire monomer units forming the vinyl polymer (A). No particular limitation is imposed on the upper limit of the content. When a monomer other than the hydrocarbyl (meth)acrylate ester compound is used, the amount is preferably 95 mass % or less, still more preferably 90 mass % or less, with respect to the amount of the entire monomer units forming the vinyl polymer (A).

In the production of the vinyl polymer (A), among these compounds, an alicyclic vinyl monomer is preferably used, since the monomer allows the glass transition temperature Tg_{A} to be relatively high, and realizes strong bonding of fiber fabrics at the bonding portion. Examples of the monomer include isobornyl (meth)acrylate, dicyclopentanyl (meth)acrylate, cyclohexyl (meth)acrylate, and adamantyl (meth)acrylate. The specific amount of the alicyclic vinyl monomer used is preferably 10 mass % to 90 mass % inclusive, more preferably 20 mass % to 80 mass % inclusive, still more preferably 30 mass % to 70 mass % inclusive, with respect to the amount of the entire monomer units forming the vinyl polymer (A).

That is, the vinyl polymer (A) preferably contains structural units derived from the alicyclic vinyl monomer in an amount of 10 mass % or more, more preferably 20 mass % or more, still more preferably 30 mass % or more, with respect to the amount of the entire monomer units forming the vinyl polymer (A). The amount of structural units derived from the alicyclic vinyl monomer in the vinyl polymer (A) is preferably 90 mass % or less, more preferably 80 mass % or less, still more preferably 70 mass % or less, with respect to the amount of the entire monomer units forming the vinyl polymer (A). The amount of structural units derived from the alicyclic vinyl monomer in the vinyl polymer (A) is preferably 10 mass % to 90 mass % inclusive, more preferably 20 mass % to 80 mass % inclusive, still more preferably 30 mass % to 70 mass % inclusive, with respect to the amount of the entire monomer units forming the vinyl polymer (A).

The number average molecular weight (Mn) of the vinyl polymer (A) is 500 to 10,000 inclusive. The Mn of the vinyl polymer (A) is preferably 1,000 or higher. The Mn of the vinyl polymer (A) is preferably 7,000 or lower, more preferably 5,000 or lower. When Mn is in excess of 10,000, compatibility of the vinyl polymer (A) with the acrylic adhesive polymer (B) is impaired, whereas when a vinyl polymer (A) having an Mn lower than 500 is produced, a polymerization initiator and a chain-transfer agent must be used in large amounts, and productivity lowers. Both cases have issues. The Mn of the vinyl polymer (A) is preferably 500 to 7,000 inclusive, still more preferably 1,000 to 5,000 inclusive.

Also, the ratio (Mw/Mn) of the vinyl polymer (A), wherein Mw represents a weight average molecular weight and Mn is described above, is preferably 3.0 or less, from the viewpoint of readily attaining favorable bonding strength. The Mw/Mn is more preferably 2.5 or less, still more preferably 2.0 or less, yet more preferably 1.8 or less. No particular limitation is imposed on the lower limit of the Mw/Mn of the vinyl polymer (A), and the Mw/Mn may be tuned to 1.0 or higher. Notably, in the present specification, the weight average molecular weight (Mw) of a relevant polymer and the number average molecular weight (Mn) thereof are standard polystyrene-reduced values obtained through gel permeation chromatography (GPC).

In one or more embodiments, the vinyl polymer (A) has such a property as to cause phase separation with the below-mentioned acrylic adhesive polymer (B). As a result, in the adhesive layer formed by use of the adhesive composition, the vinyl polymer (A) readily segregates at the surface portion. These skilled in the art can easily design the vinyl polymer (A) which causes phase separation with the acrylic adhesive polymer (B) on the basis of the common general knowledge at the time of filing the present patent application. For example, the difference ΔSP (absolute value) between the SP value (i.e., a known solubility parameter) of the vinyl polymer (A) (which is calculated through a calculation method such as the Fedors method) and that of the acrylic adhesive polymer (B) is adjusted to 0.01 or greater. The difference value ΔSP may be, for example, 0.05 or greater, 0.1 or greater, 0.2 or greater, or 0.5 or greater. In employment of the Fedors method, the SP value can be calculated through the calculation method disclosed in R. F. Fedors, “Polymer Engineering and Science” 14(2), 147 (1974). Alternatively, the SP value, showing a phase separation degree between blocks, may be readily estimated by preparing a polymer blend of the vinyl polymer (A) of interest and the acrylic adhesive polymer (B) of interest and observing the structure of the resultant mixture through an analytical technique such as electron microscopy, atomic force microscopy, or small angle X-ray scattering.

No particular limitation is imposed on the method of producing the vinyl polymer (A). For example, the polymer (A) can be readily produced through, for example, polymerizing the aforementioned monomer(s) via a known radical polymerization technique such as solution polymerization. In the case of solution polymerization, an organic solvent and a vinyl monomer or monomers serving as raw material(s) is/are fed to a reactor, and a thermal polymerization initiator such as an organic peroxide or an azo compound is added thereto. Then, the mixture is allowed to copolymerize by heating it at 50 to 300° C., to thereby yield a vinyl polymer (A) of interest. In preparation of the adhesive composition, the vinyl polymer (A) may be a solution in organic solvent, or the solvent may be removed through distillation (e.g., heating under reduced pressure).

No particular limitation is imposed on the method of feeding raw materials including monomers. All the raw materials may be collectively fed to a reactor in an initial stage (i.e., in a batch manner), or at least one raw material may be continuously fed to a reactor (i.e., in a semi-continuous manner). In an alternative manner, all the raw materials are continuously fed to a reactor, and the formed resin is continuously and simultaneously extracted from the reactor (i.e., continuous polymerization).

The organic solvent employed in solution polymerization is preferably an organic hydrocarbon compound. Examples of the organic hydrocarbon compound include a cyclic ether such as tetrahydrofuran and dioxane; aromatic hydrocarbons such as benzene, toluene, and xylene; esters such as ethyl acetate and butyl acetate; ketones such as acetone, methyl ethyl ketone, and cyclohexanone; methyl orthoformate and methyl orthoacetate; and alcohols such as methanol, ethanol, and isopropanol. These solvents may be used singly or in combination of two or more species. Among these organic solvents, an organic solvent having a relatively low boiling point is preferred, from the viewpoints of attaining high solubility of the vinyl polymer (A) and easiness of purification. Specific examples of the organic solvent include ethyl acetate, butyl acetate, acetone, and methyl ethyl ketone.

No particular limitation is imposed on the polymerization initiator employed in the present specification, and an azo compound, an organic peroxide, an inorganic peroxide, etc. may be used. As a polymerization initiator, a redox-type polymerization initiator formed of a known oxidizing agent and a known reducing agent may be used. Alternatively, a known chain-transfer agent may be used in combination with the polymerization initiator.

Examples of the azo compound include 2,2′-azobis(isobutyronitrile), 1,1-azobis(cyclohexane-1-carbonitrile), azocumene, 2,2′-azobis(2-methylbutyronitrile), 2,2′-azobis(2,4-dimethylvaleronitrile), 4,4′-azobis(4-cyanovaleric acid), 2-(tert-butylazo)-2-cyanopropane, 2,2′-azobis(2,4,4-trimethylpentane), 2,2′-azobis(2-methylpropane), and dimethyl-2,2′-azobis(2-methylpropionate).

Examples of the organic peroxide include cyclohexanone peroxide, 3,3,5-trimethylcyclohexanone peroxide, methylcyclohexanone peroxide, 1,1-bis(tert-butylperoxy)-3,3,5-trimethylcyclohexane, 1,1-bis(tert-butylperoxy)cyclohexane, n-butyl-4,4-bis(tert-butylperoxy)valerate, cumene hydroperoxide, 2,5-dimethylhexane 2,5-dihydroperoxide, 1,3-bis[(tert-butylperoxy)-m-isopropyl]benzene, 2,5-dimethyl-2,5-di(tert-butylperoxy) hexane, diisopropylbenzeneperoxide, tert-butylcumyl peroxide, decanoyl peroxide, lauroyl peroxide, benzoyl peroxide, 2,4-dichlorobenzoyl peroxide, bis(tert-butylcyclohexyl) peroxydicarbonate, tert-butyl peroxybenzoate, and 2,5-dimethyl-2,5-di(benzoylperoxy)hexane.

Examples of the inorganic peroxide include potassium persulfate, sodium persulfate, and ammonium persulfate.

As the redox-type polymerization initiator, there may be used a combination of a reducing agent (e.g., sodium sulfite, sodium thiosulfate, sodium formaldehyde sulfoxylate, ascorbic acid, or ferrous sulfate) and an oxidizing agent (e.g., potassium peroxodisulfate, hydrogen peroxide, or tert-butyl hydroperoxide).

Alternatively, the vinyl polymer (A) may be produced through continuous polymerization at 180 to 350° C. by means of a stirred vessel reactor. In continuous polymerization, a vinyl polymer of low molecular weight can be produced with no substantial use of a polymerization initiator or a chain-transfer agent. As a result, a high-purity polymer can be produced, and the below-mentioned defective coloring and generation of odor is prevented, which is advantageous and preferred. When the polymerization temperature is lower than 180° C., a polymerization initiator or a large amount of chain-transfer agent will be required in the polymerization reaction. As a result, the produced vinyl polymer (A) is readily colored, and unfavorable odor is generated. When the polymerization temperature is higher than 350° C., degradation readily occurs in the polymerization reaction, and the produced vinyl polymer (A) is colored. Thus, the transparency of the adhesive layer obtained from an adhesive composition containing such a product may be impaired. In addition, through continuous polymerization, the produced vinyl polymer (A) has a narrow molecular weight distribution profile. Notably, a polymerization initiator may be arbitrarily used, and the amount of the initiator used is preferably about 1 mass % or less with respect to the entire amount of monomers.

### [Acrylic Adhesive Polymer (B)]

The acrylic adhesive polymer (B) of the present disclosure is a polymer formed of a (meth)acrylate ester compound as a main structural unit and has adhesion. The glass transition temperature Tg_{B} of the acrylic adhesive polymer (B) is preferably −80° C. to 10° C. inclusive, more preferably −80° C. to 0° C., still more preferably −80° C. to −20° C. inclusive, particularly preferably −80° C. to −30° C. inclusive. When the glass transition temperature Tg_{B} is lower than −80° C., the cohesive force of the produced adhesive layer is insufficient, to thereby possibly reduce the shear adhesion. When glass transition temperature Tg_{B} is higher than 0° C., the texture of the bonded fiber fabrics is insufficient in some cases.

As a monomer forming the acrylic adhesive polymer (B), an alkyl (meth)acrylate having a C4 to C12 alkyl group, an alkoxyalkyl (meth)acrylate having a C2 to C12 alkoxyalkyl group, or the like is preferably used, from the viewpoint of forming an acrylic polymer having a low glass transition temperature Tg_{B} and adhesion. As a monomer forming the acrylic adhesive polymer (B), one or more species of such compounds may be used.

Examples of the alkyl (meth)acrylate having a C4 to C12 alkyl group include n-butyl (meth)acrylate, isobutyl (meth)acrylate, n-hexyl (meth)acrylate, n-octyl (meth) acrylate, isooctyl (meth) acrylate, 2-ethylhexyl (meth) acrylate, n-nonyl (meth) acrylate, isononyl (meth)acrylate, n-decyl (meth)acrylate, and lauryl (meth)acrylate. Among them, n-butyl (meth)acrylate, 2-ethylhexyl (meth)acrylate, n-octyl (meth)acrylate, isooctyl (meth) acrylate, n-nonyl (meth) acrylate, isononyl (meth)acrylate, etc. are preferred monomers.

Examples of the alkoxyalkyl (meth)acrylate having a C2 to C12 alkoxyalkyl group include methoxymethyl (meth)acrylate, ethoxymethyl (meth)acrylate, butoxymethyl (meth)acrylate, methoxyethyl (meth) acrylate, ethoxyethyl (meth) acrylate, butoxyethyl (meth)acrylate, methoxybutyl (meth)acrylate, ethoxybutyl (meth)acrylate, and butoxybutyl (meth)acrylate.

In the acrylic adhesive polymer (B), the amount of structural units derived from the alkyl (meth)acrylate having a C4 to C12 alkyl group and/or the alkoxyalkyl (meth)acrylate having a C2 to C12 alkoxyalkyl group is preferably 30 mass % to 100 mass % inclusive, more preferably 35 mass % to 99 mass % inclusive, still more preferably 50 mass % to 99 mass % inclusive, with respect to the amount of the entire monomer units forming the acrylic adhesive polymer (B). When this content is adjusted to 30 mass % or more, the produced adhesive composition exhibits satisfactory tackiness, initial adhesion (tack), low-temperature tackiness, etc., which is preferred.

Among the above monomers, the monomer forming the acrylic adhesive polymer (B) is more preferably an alkoxyalkyl (meth)acrylate, since the monomer exhibits excellent adhesive performance and promotes segregation of the vinyl polymer (A) to the surface layer in the adhesive layer. The amount of structural units derived from the alkoxyalkyl (meth)acrylate is preferably 30 mass % or more, more preferably 40 mass % or more, still more preferably 45 mass % or more, yet more preferably 50 mass % or more, further more preferably 60 mass % or more, further more preferably 70 mass % or more, particularly preferably 80 mass % or more, with respect to the amount of the entire monomer units forming the acrylic adhesive polymer (B). No particular limitation is imposed on the upper limit of the relative amount of structural units derived from the alkoxyalkyl (meth)acrylate, and the relative amount is 100 mass % or lower.

In the production of acrylic adhesive polymer (B), preferably used is a compound serving as a monomer unit of a homopolymer having a solubility parameter (SP value) determined through the Fedors method of 9.9 or higher, since the compound promotes segregation of the vinyl polymer (A) to the surface layer in the adhesive layer. Examples of the monomer providing a homopolymer with an SP value of 9.9 or higher include methyl (meth)acrylate, ethyl acrylate, methoxyethyl acrylate, ethoxyethyl acrylate, hydroxyethyl (meth) acrylate, acryloylmorpholine, (meth)acrylic acid, styrene, and benzyl methacrylate. The acrylic adhesive polymer (B) may contain structural units derived from such monomers preferably in an amount of 10 mass % or more, more preferably 20 mass % or more, still more preferably 30 mass % or more, particularly preferably 50 mass % or more, with respect to the entire monomer units forming the acrylic adhesive polymer (B).

So long as the adhesive performance is not impaired, the acrylic adhesive polymer (B) may include other monomers which can copolymerize with the aforementioned the alkyl (meth)acrylate having a C4 to C12 alkyl group and/or the alkoxyalkyl (meth)acrylate having a C2 to C12 alkoxyalkyl group. Examples of the copolymerizable monomer include alkyl (meth)acrylate having a C1 to C3 alkyl group; unsaturated carboxylic acids such as (meth)acrylic acid, itaconic acid, maleic acid, fumaric acid, and unsaturated dicarboxylic acid monoalkyl esters (e.g., monoethyl itaconate and monobutyl fumarate); aromatic vinyl compounds such as styrene, α-methylstyrene, and vinyltoluene; alicyclic vinyl monomers; alicyclic vinyl monomers such as cyclohexyl (meth)acrylate, methylcyclohexyl (meth) acrylate, tert-butylcyclohexyl (meth)acrylate, cyclododecyl (meth)acrylate, and isobornyl (meth) acrylate; hydroxy group-containing unsaturated compounds such as 2-hydroxyethyl (meth)acrylate, 3-hydroxypropyl (meth)acrylate, 4-hydroxybutyl (meth)acrylate, polyethylene glycol (meth)acrylate, polypropylene glycol (meth) acrylate, and polyethylene-polypropyrene glycol mono(meth)acrylate; amido group-containing unsaturated compounds such as acrylamide, N-methylolacrylamide, N-methoxymethylacrylamide, N-methoxybutylacrylamide, and N-substituted compounds thereof; unsaturated alcohols such as allyl alcohol; and (meth)acrylonitrile, vinyl acetate, glycidyl (meth)acrylate, and diacetone acrylamide. These monomers may be used singly or in combination of two or more species.

Other than the above monomers, there may be used a multi-functional polymerizable monomer having two or more polymerizable functional groups (e.g., a (meth)acryloyl group and an alkenyl group) in the molecule thereof. Examples of the multi-functional polymerizable monomer include a multi-functional (meth)acrylate compound, a multi-functional alkenyl compound, and a compound having both a (meth)acryloyl group and an alkenyl group.

Examples of the multi-functional (meth)acrylate compound include dihydric alcohol di(meth)acrylates such as ethylene glycol di(meth)acrylate, propylene glycol di(meth)acrylate, 1,6-hexanediol di(meth)acrylate, polyethylene glycol di(meth)acrylate, and polypropylene glycol di(meth)acrylate; and poly(≥3)hydric alcohol poly(meth)acrylate (e.g., tri(meth)acrylate or tetra(meth)acrylate) such as trimethylolpropane tri(meth)acrylate, ethylene oxide-modified trimethylolpropane tri(meth)acrylate, glycerin tri(meth)acrylate, pentaerythritol tri(meth)acrylate, and pentaerythritol tetra(meth)acrylate.

Examples of the multi-functional alkenyl compound include multi-functional allyl ether compounds such as trimethylolpropane diallyl ether, pentaerythritol diallyl ether, pentaerythritol triallyl ether, tetraallyloxyethane, and polyallyl saccharose; multi-functional allyl compounds such as diallyl phthalate; bisamides such as methylenebisacrylamide and hydroxyethylenebisacrylamide; and multi-functional vinyl compounds such as divinylbenzene.

Examples of the compound having both a (meth)acryloyl group and an alkenyl group include allyl (meth)acrylate, isopropenyl (meth)acrylate, butenyl (meth)acrylate, pentenyl (meth)acrylate, and 2-(2-vinyloxyethoxy)ethyl (meth)acrylate.

From the viewpoint of attaining sufficient cohesive force and excellent adhesion, the acrylic adhesive polymer (B) preferably has a weight average molecular weight (Mw) of 100,000 or higher, more preferably 250,000 or higher, still more preferably 400,000 or higher. However, when the weight average molecular weight is excessively high, difficulty is encountered in handling the polymer product in the production thereof. Thus, the Mw of the acrylic adhesive polymer (B) is preferably 2,000,000 or lower, more preferably 1,500,000 or lower, still more preferably 1,000,000 or lower.

From the viewpoint of attaining excellent adhesion, the number average molecular weight (Mn) of the acrylic adhesive polymer (B) is preferably 30,000 or higher, more preferably 50,000 or higher, still more preferably 70,000 or higher. From the viewpoints of realizing easy production and attaining favorable compatibility with the vinyl polymer (A), the Mn of the acrylic adhesive polymer (B) is preferably 500,000 or lower, more preferably 400,000 or lower, still more preferably 300,000 or lower. Thus, the range of Mn of the acrylic adhesive polymer (B) is preferably 30,000 to 500,000 inclusive, more preferably 50,000 to 400,000 inclusive.

From the viewpoint of easily attaining favorable bonding strength, the ratio of Mw to Mn (Mw/Mn) of the acrylic adhesive polymer (B) is preferably 8.0 or less, more preferably 7.5 or less, still more preferably 7.0 or less. No particular limitation is imposed on the lower limit of Mw/Mn of the acrylic adhesive polymer (B), and the lower limit may be 1.0 or higher.

The acrylic adhesive polymer (B) can be produced also through a known radical polymerization technique such as solution polymerization, suspension polymerization, or emulsion polymerization.

### [Adhesive Composition]

The present adhesive composition contains a vinyl polymer (A) and an acrylic adhesive polymer (B). The vinyl polymer (A) preferably has an appropriate compatibility with the acrylic adhesive polymer (B). Under such conditions, the adhesive layer formed from the adhesive composition containing the above ingredients exhibits high transparency. Also, a part of the vinyl polymer (A) segregates in the adhesive layer, whereby the vinyl polymer (A) concentration may be higher in the surface portion than in other portions of the adhesive layer, which is preferred.

In the case where the vinyl polymer (A) concentration is higher in the surface portion than in other portions of the adhesive layer, a portion of the adhesive layer in the vicinity of the adhesion interface has a comparatively high Tg. By virtue of such a high Tg, the adhesive layer can exhibit high peel strength and tensile shear bonding strength. The segregation behavior of the vinyl polymer (A) in the present adhesive composition, and the below-mentioned difference in Tg between Tg₂ of the surface portion of the adhesive layer and Tg₁ of the adhesive composition can be regulated by appropriately setting the feed ratio of vinyl polymer (A) to acrylic adhesive polymer (B), the monomer composition (polarity) and molecular weight of the vinyl polymer (A), Tg, Mw/Mn, the monomer composition of the acrylic adhesive polymer (B), and other factors.

In one or more embodiments, the present adhesive composition contains the vinyl polymer (A) in an amount (as solid content) of 0.5 parts by mass to 60 parts by mass inclusive, with respect to 100 parts by mass of the acrylic adhesive polymer (B). The lower limit of the vinyl polymer (A) content with respect to 100 parts by mass of the acrylic adhesive polymer (B) is preferably 1 part by mass or more, more preferably 3 parts by mass or more, still more preferably 4 parts by mass or more. The upper limit of the vinyl polymer (A) content with respect to 100 parts by mass of the acrylic adhesive polymer (B) is preferably 50 parts by mass or less, more preferably 40 parts by mass or less, still more preferably 30 parts by mass or less, yet more preferably parts by mass or less. The range of the content is preferably 1 part by mass to 40 parts by mass inclusive, more preferably 3 parts by mass to 30 parts by mass inclusive, still more preferably 4 parts by mass to 30 parts by mass inclusive, yet more preferably 4 parts by mass to 10 parts by mass inclusive. When the vinyl polymer (A) content is 0.5 parts by mass or more, the vinyl polymer (A) sufficiently segregates in the surface portion of the adhesive layer, to thereby attain high peel strength and tensile shear bonding strength. When the content is 60 parts by mass or less, excessive segregation of the vinyl polymer (A) is prevented, to thereby attain sufficient adhesion (including tack). Also, a drop in transparency of the adhesive layer, which would otherwise be caused by phase separation from the acrylic adhesive polymer (B) can be suppressed.

### [Cross-Linking Agent]

The present adhesive composition may contain a cross-linking agent. Although the cross-linking agent is not an essential ingredient, addition of the agent is considered according to the target adhesive property, the form of the present adhesive composition (e.g., emulsion, solution, etc.), and other factors. By virtue of the presence of the cross-linking agent, the cohesive force and adhesion of the adhesive layer formed from the present adhesive composition are controlled, and adhesion and tensile shear bonding strength can also be sufficiently imparted to the adhesive layer under high-temperature and -moisture conditions, which is preferred. Examples of the cross-linking agent include an aziridine compound having two or more aziridinyl groups, a glycidyl compound having two or more glycidyl groups, an isocyanate compound having two or more isocyanate groups, an oxazoline compound having an oxazoline group, a metal chelate compound, and a butylated melamine compound. Among them, at least one species selected from the group consisting of an aziridine compound, a glycidyl compound, and an isocyanate compound is preferably used.

Examples of the aziridine compound include 1,6-bis(1-aziridinylcarbonylamino) hexane, 1,1′-(methylenedi-p-phenylene) bis(3,3-aziridylurea), 1,1′-(hexamethylene) bis(3,3-aziridylurea), ethylenebis(2-aziridinylpropionate), tris(1-aziridinyl)phosphine oxide, 2,4,6-triaziridinyl-1,3,5-triazine, and trimethylolpropane tris(2-aziridinylpropionate).

Examples of the glycidyl compound include multi-functional glycidyl compounds such as ethylene glycol diglycidyl ether, polyethylene glycol diglycidyl ether, propylene glycol diglycidyl ether, polypropylene glycol diglycidyl ether, glycerin diglycidyl ether, neopentyl glycol diglycidyl ether, 1,6-hexanediol diglycidyl ether, tetraglycidylxylenediamine, 1,3-bis(N,N-diglycidylaminomethyl)cyclohexane, trimethylolpropane polyglycidyl ether, diglycerol polyglycidyl ether, polyglycerol polyglycidyl ether, and sorbitol polyglycidyl ether.

The isocyanate compound is preferably a compound having two or more isocyanate groups. As the isocyanate compound, there can be used various isocyanate compounds including aromatic isocyanates, aliphatic isocyanates, and alicyclic isocyanates; and modified products (e.g., prepolymers) of the isocyanate compounds.

Examples of the aromatic isocyanate include diphenylmethane diisocyanate (MDI), crude diphenylmethane diisocyanate, tolylene diisocyanate, naphthalene diisocyanate (NDI), p-phenylene diisocyanate (PPDI), xylene diisocyanate (XDI), tetramethylxylylene diisocyanate (TMXDI), and tolidine diisocyanate (TODI). Examples of the aliphatic isocyanate include hexamethylene diisocyanate (HDI), lysine diisocyanate (LDI), and lysine triisocyanate (LTI). Examples of the alicyclic isocyanate include isophorone diisocyanate (IPDI), cyclohexyl diisocyanate (CHDI), hydrogenated XDI (H6XDI), and hydrogenated MDI (H12MDI). Examples of the modified isocyanate include urethane-modified products, dimers, trimers, carbodiimido-modified products, allophanate-modified products, biuret-modified products, urea-modified products, isocyanurate-modified products, oxazolidone-modified products, and isocyanate-terminated prepolymers of the afformentioned isocyanate compounds.

The cross-linking agent content is preferably 0.01 parts by mass to 10 parts by mass inclusive, with respect to 100 parts by mass of the acrylic adhesive polymer (B). The more preferred lower limit is 0.03 parts by mass or more, still more preferably 0.05 parts by mass or more. The more preferred upper limit is 5 parts by mass or less, still more preferably 2 parts by mass or less. The more preferred range of the content is 0.03 parts by mass to 5 parts by mass inclusive, further more preferably 0.05 parts by mass to 2 parts by mass inclusive.

Other than the vinyl polymer (A) and the acrylic adhesive polymer (B), if required, the present adhesive composition may further contain additives such as a tackifier, a plasticizer, an antioxidant, a UV-absorber, an anti-aging agent, a flame retardant, a fungicide, a silane coupling agent, a filler, and a colorant.

Examples of the tackifier include rosin derivatives such as rosin ester, gum rosin, tall oil rosin, hydrogenated rosin ester, maleated rosin, and disproportionated rosin ester; terpene phenol resin and terpene resins mainly formed of α-pinene, β-pinene, limonene, etc.; (hydrogenated) petroleum resins; coumarone-indene resins; hydrogenated aromatic copolymers; styrene resins; phenol resins; xylene resins; and (meth)acrylic polymers.

Examples of the plasticizer include phtalate esters such as di(n-butyl) phthalate, di(n-octyl) phthalate, bis(2-ethylhexyl) phthalate, di(n-decyl) phthalate, and diisodecyl phthalate; adipate esters such as bis(2-ethylhexyl) adipate and di(n-octyl) adipate; sebacate esters such as bis(2-ethylhexyl) sebacate and di(n-butyl) sebacate; azelate esters such as bis(2-ethylhexyl) azelate; paraffins such as chlorinated paraffin; glycols such as polypropylene glycol; epoxy-modified vegetable oils such as epoxy-modified soy bean oil and epoxy-modified linseed oil; phosphate esters such as trioctyl phosphate and triphenyl phosphate; phosphite esters such as triphenyl phosphite; ester oligomers such as 1,3-butylene glycol adipic acid ester; low-molecular weight polymers such as low-molecular weight polybutene, low-molecular weight polyisobutylene, and low-molecular weight polyisoprene; and oils such as process oil and naphthene-based oil.

Examples of the antioxidant include phenol-type antioxidants such as 2,6-di-tert-butyl-p-cresol, butylated hydroxyanisole, 2,6-di-tert-butyl-4-ethylphenol, stearyl β-(3,5-di-tert-butyl-4-hydroxyphenyl)propionate, 2,2′-methylenebis(4-methyl-6-tert-butylphenol), 2,2′-methylenebis(4-ethyl-6-tert-butylphenol), 4,4′-thiobis(3-methyl-6-tert-butylphenol), 4,4′-butylidenebis(3-methyl-6-tert-butylphenol), 3,9-bis[1,1-dimethyl-2-[β-(3-tert-butyl-4-hydroxy-5-methylphenyl)propionyloxy]ethyl]2,4,8,10-tetraoxaspiro[5.5]undecane, 1,3-tris(2-methyl-4-hydroxy-5-tert-butylphenyl)butane, 1,3,5-trimethyl-2,4,6-tris(3,5-di-tert-butyl-4-hydroxybenzyl)benzene, tetrakis-[methylene-3-(3′,5′-di-tert-butyl-4′-hydroxyphenyl)propionate]methane, bis[3,3′-bis(4′-hydroxy-3′-tert-butylphenyl)butyric acid] glycol ester, 1,3,5-tris(3′,5′-di-tert-butyl-4′-hydroxybenzyl)-S-triazine-2,4,6-(1H,3H,5H)-trione, and tocopherol; sulfur-containing antioxidants such as dilauryl 3,3′-thiodipropionate, dimyristyl 3,3′-thiodipropionate, and stearyl 3,3′-thiodipropionate; and phosphorus-containing antioxidants such as triphenyl phosphite, diphenyl isodecyl phosphite, 4,4′-butylidene-bis(3-methyl-6-tert-butylphenylditridecyl) phosphite, cyclic neopentanetetrayl bis(octadecyl phosphite), tris(nonylphenyl) phosphite, tris(monononylphenyl) phosphite, tris(dinonylphenyl) phosphite, diisodecylpentaerythritol diphosphite, 9,10-dihydro-9-oxa-10-phosphaphenanthrene-10-oxide, 10-(3,5-di-tert-butyl-4-hydroxybenzyl)-9,10-dihydro-9-oxa-10-phosphaphenanthrene-10-oxide, 10-desiloxy-9,10-dihydro-9-oxa-10-phosphaphenanthrene, tris(2,4-di-tert-butylphenyl) phosphite, cyclic neopentanetetrayl bis(2,4-di-tert-butylphenyl) phosphite, cyclic neopentanetetrayl bis(2,6-di-tert-butyl-4-methylphenyl) phosphite, and 2,2-methylenebis(4,6-di-tert-butylphenyl)octyl phosphite.

Examples of the UV-absorber include salicylic acid-type UV absorbers such as phenyl salicylate, p-tert-butylphenyl salicylate, and p-octylphenyl salicylate; benzophenone-type UV absorbers such as 2,4-dihydroxybenzophenone, 2-hydroxy-4-methoxybenzophenone, 2-hydroxy-4-octoxybenzophenone, 2-hydroxy-4-dodecyloxybenzophenone, 2,2′-dihydroxy-4-methoxybenzophenone, 2,2′-dihydroxy-4,4′-dimethoxybenzophenone, 2-hydroxy-4-methoxy-5-sulfobenzophenone, and bis(2-methoxy-4-hydroxy-5-benzoylphenyl)methane; benzotriazole-type UV absorbers such as 2-(2′-hydroxy-5′-methylphenyl)benzotriazole, 2-(2′-hydroxy-5′-tert-butylphenyl)benzotriazole, 2-(2′-hydroxy-3′,5′-di-tert-butylphenyl)benzotriazole, 2-(2′-hydroxy-3′-tert-butyl-5′-methylphenyl)-5-chlorobenzotriazole, 2-(2′-hydroxy-3′,5′-di-tert-butylphenyl)-5-chlorobenzotriazole, 2-(2′-hydroxy-3′,5′-di-tert-amylphenyl)benzotriazole, 2-(2′-hydroxy-4′-octoxyphenyl)benzotriazole, 2-[2′-hydroxy-3′-(3″,4″,5″,6″-tetrahydrophthalimidomethyl)-5′-methylphenyl]benzotriazole, 2,2-methylenebis[4-(1,1,3,3-tetramethylbutyl)-6-(2H-benzotriazol-2-yl)phenol], 2-(2′-hydroxy-5′-methacryoxyphenyl)-2H-benzotriazole, and 2,2′-methylenebis[4-(1,1,3,3-tetramethylbutyl)-6-(2H-benzotriazol-2-yl)phenol]; cyanoacrylate UV-absorbers such as 2-ethylhexyl-2-cyano-3,3′-diphenylacrylate and ethyl-2-cyano-3,3′-diphenylacrylate; and nickel-containing UV stabilizers such as nickel bis(octylphenyl)sulfide, [2,2′-thiobis(4-tert-octylphenolato)]-n-butylaminenickel, nickel complex-3,5-di-tert-butyl-4-hydroxybenzylphosphoric acid monoethylate, and nickel-dibutyldithiocarbamate.

Examples of the anti-aging agent include poly(2,2,4-trimethyl-1,2-dihydroquinoline), 6-ethoxy-1,2-dihydro-2,2,4-trimethylquinoline, 1-(N-phenylamino)-naphthalene, styrenated diphenylamine, dialkyldiphenylamine, N,N′-diphenyl-p-phenylenediamine, N-phenyl-N′-isopropyl-p-phenylenediamine, N,N′-di-2-naphthyl-p-phenylenediamine, 2,6-di-tert-butyl-4-methylphenol, mono(α-methylbenzyl)phenol, di(α-methylbenzyl)phenol, tri(α-methylbenzyl)phenol, 2,2′-methylenebis(4-methyl-6-tert-butylphenol), 2,2′-methylenebis(4-ethyl-6-tert-butylphenol), 4,4′-butylidenebis(6-tert-butyl-3-methylphenol), 4,4′-thiobis(6-tert-butyl-3-methylphenol), 1,1-bis(4-hydroxyphenyl)cyclohexane, 2,5-di-tert-butylhydroquinone, 2,5-di-tert-amylhydroquinone, 2-mercaptobenzimidazole, 2-mercaptobenzimidazole zinc salt, 2-mercaptomethylbenzimidazole, nickel dibutyldithiocarbamate, tris(nonylphenyl) phosphite, dilauryl thiodipropionate, and distearyl thiodipropionate.

Examples of the flame retardant include halogen-containing flame retardants such as tetrabromobisphenol A, 2,2-bis(4-hydroxy-3,5-dibromophenyl)propane, hexabromobenzene, tris(2,3-dibromopropyl) isocyanurate, 2,2-bis(4-hydroxyethoxy-3,5-dibromophenyl)propane, decabromodiphenyl oxide, and halo-containing polyphosphate; phosphorus-containing flame retardants such as ammonium phosphate, tricredyl phosphate, triethyl phosphate, tris(β-chloroethyl) phosphate, trischloroethyl phosphate, tris(dichloropropyl) phosphate, credyldiphenyl phosphate, xylenyldiphenyl phosphate, acidic phosphate ester, and azo phosphorus compounds; inorganic flame retardants such as red phosphorus, tin oxide, antimony trioxide, zirconium hydroxide, barium metaborate, aluminum hydroxide, and magnesium hydroxide; and siloxane-based flame retardants such as poly(dimethoxysiloxane), poly(diethoxysiloxane), poly(diphenoxysiloxane), poly(methoxyphenoxysiloxane), methyl silicate, ethyl silicate, and phenyl silicate.

Examples of the fungicide include benzimidazole, benzothiazole, trihaloallyls, triazole, and organic azosulfo compounds.

Examples of the silane coupling agent include vinyltriethoxysilane, vinyltris(β-methoxyethoxy)silane, γ-methacryloxypropyltrimethoxysilane, vinyltriacetoxysilane, γ-glycidoxypropyltrimethoxysilane, γ-glycidoxypropyltriethoxysilane, β-(3,4-epoxycyclohexyl)ethyltrimethoxysilane, γ-chloropropylmethoxysilane, vinyltrichlorosilane, γ-mercaptopropyltrimethoxysilane, γ-aminopropyltriethoxysilane, and N-β(aminoethyl)-γ-aminopropyltrimethoxysilane.

Examples of the filler include inorganic powder fillers such as calcium carbonate, titanium oxide, mica, and talc; and fibrous fillers such as glass fiber and organic reinforcing fiber. So long as the effects of the present disclosure are not impaired, the additive content may be appropriately tuned in accordance with the type of additive employed.

No particular limitation is imposed on the form of the present adhesive composition, so long as the composition contains the vinyl polymer (A) and the acrylic adhesive polymer (B). For example, the composition may be used as a solution-type adhesive composition in which the ingredients are dissolved in an organic solvent such as ethyl acetate. Alternatively, the composition may be used as an emulsion-type adhesive composition in which the acrylic adhesive polymer and a tackifier are dispersed in an aqueous medium. When the composition is used in the form of a solution-type adhesive composition or an emulsion-type adhesive composition, the amount of the solvent such as an organic solvent or water is generally 20 to 80 parts by mass, with respect to 100 parts by mass of the adhesive composition.

When the composition is used as a solution-type adhesive composition, the solvent used in the preparation of the adhesive composition is preferably an organic solvent which can solve the vinyl polymer (A) and the acrylic adhesive polymer (B). Specific examples of the solvent include an aprotic polar solvent, a phenolic solvent, an alcoholic solvent, an esteric solvent, a ketonic solvent, an etheric solvent, and a hydrocarbon solvent. The organic solvent may be a single solvent or a mixture of two or more members.

When the composition is used as a solution-type adhesive composition, no particular limitation is imposed on the solid content of the adhesive composition (i.e., the ratio of the mass of the ingredients excepting the solvent to the entire mass of the adhesive composition), and the solid content is preferably 1 to 70 mass %. When the solid content is 1 mass % or more, the formed adhesive layer can have sufficient thickness, which is preferred. When the solid content is 70 mass % or less, favorable coatability is ensured, and an adhesive layer having a uniform thickness is formed, which is preferred. The solid content of the adhesive composition is more preferably 5 to 50 mass %, still more preferably 10 to 45 mass %.

When the composition is used as an emulsion-type adhesive composition, a stabilizer may be incorporated thereinto. Examples of the stabilizer include stabilizers for vinyl chloride such as cadmium stearate, zinc stearate, barium stearate, calcium stearate, lead dibutyltindilaurate, tris(nonylphenyl) phosphite, triphenyl phosphite, and diphenylisodecyl phosphite; organic tin stabilizers such as di-n-octyltin bis(isooctylthioglycolate ester) salt, di-n-octyltin maleate salt polymer, di-n-octyltin dilaurate salt, di-n-octyltin maleate ester salt, di-n-butyltin bismaleate ester salt, di-n-butyltin maleate salt polymer, di-n-butyltin bisoctylthioglycolate salt, di-n-butyltin β-mercaptopropionate polymer, di-n-butyltin dilaurate, di-n-methyltin bis(isooctylmercaptoacetate) salt, poly(thiobis(n-butyltin) sulfide), monooctyltin tris(isooctylthioglycolate), dibutyltin maleate, and di-n-butyltin maleate/carboxylate ester mercaptide; lead-containing stabilizers such as tribasic lead sulfate, dibasic lead phosphite, basic lead phosphite, dibasic lead phthalate, lead silicate, dibasic lead stearate, and lead stearate; and metal soap-type stabilizers such as cadmium soap, zinc soap, barium soap, lead soap, mixed metal soap, and calcium stearate.

Other than the aforementioned vinyl polymer (A) and acrylic adhesive polymer (B), the present adhesive composition may further contain monofunctional and/or multi-functional (meth)acrylic monomers and a photo-polymerization initiator. In this case, there may be provide a so-called syrup form, photocurable adhesive composition which can be cured through an active energy ray such as a UV ray.

In the case of the photocurable adhesive composition, the composition may contain an organic solvent or the like. However, the composition is generally used as a solvent-free composition containing no solvent.

Examples of the monofunctional (meth)acrylate monomer include alkyl (meth)acrylate esters having a C1 to C12 alkyl group; (meth)acrylate esters having a cyclic structure such as cyclohexyl (meth)acrylate, dicyclopentyl (meth)acrylate, and isobornyl (meth)acrylate; hydroxyalkyl (meth)acrylate esters such as hydroxyethyl (meth)acrylate, hydroxypropyl (meth)acrylate, and hydroxybutyl (meth)acrylate; and (meth)acrylic acid. These compounds may be used singly or in combination of two or more species.

Examples of the multi-functional (meth)acrylate monomer include alkylene glycol di(meth)acrylates such as butanediol di(meth)acrylate and hexanediol di(meth)acrylate; polyalkylene glycol di(meth)acrylates such as triethylene glycol di(meth)acrylate; and trimethylolpropane tri(meth)acrylate and an ethylene oxide- and/or propylene oxide-modified product, pentaerythritol tri(meth)acrylate, and pentaerythritol tetra(meth)acrylate. Other than these compounds, there may be used a polymer having a (meth)acryloyl group (i.e., a macromonomer) such as a polyurethane (meth)acrylate and a polyisoprene (meth)acrylate. Specific examples of the polyisoprene (meth)acrylate compound include an ester of maleic anhydride-added isoprene polymer with 2-hydroxyethyl methacrylate. These compounds may be used singly or in combination of two or more species.

Examples of the photopolymerization initiator include benzoin and its alkyl ethers, acetophenones, anthraquinones, thioxanthones, ketals, benzophenones, xanthones, acylphosphine oxides, and α-diketones. Also, in order to enhance sensitivity to an active energy ray, a photosensitizer may be used in combination. Examples of the photosensitizer include a benzoic acid-based and an amine-based photosensitizer. These photosensitizers may be used in combination of two or more species. The amount of the photopolymerization initiator or photosensitizer used is preferably 0.01 to 10 parts by mass, with respect to 100 parts by mass of a monofunctional and/or multi-functional (meth)acrylate monomer or monomers.

Furthermore, other than the aforementioned photocurable adhesive composition, the present adhesive composition may be used as a photocurable adhesive composition containing the aforementioned vinyl polymer (A), a monofunctonal and/or multi-functional (meth)acrylate monomer, and a photopolymerization initiator. The photocurable adhesive composition may contain the acrylic adhesive polymer (B) in accordance with needs.

### [Production of Adhesive Composition]

No particular limitation is imposed on the method for producing the present adhesive composition, so long as the composition contains the vinyl polymer (A) and the acrylic adhesive polymer (B). In one production procedure, a vinyl polymer (A) and an acrylic adhesive polymer (B) are mixed together, to thereby yield the present adhesive composition. In another production procedure, an acrylic adhesive polymer (B) is formed through polymerization in the presence of a vinyl polymer (A), to thereby yield the present adhesive composition. According to one mode of the production method, the present adhesive composition can be produced by dissolving a vinyl polymer (A) in a solvent such as ethyl acetate, to thereby prepare a polymer solution; mixing the polymer solution with a polymer solution of an acrylic adhesive polymer (B); and optionally adding an additive such as a cross-linking agent thereto, in accordance with need.

### [Tg of Adhesive Composition (First Glass Transition Temperature Tg₁)]

The present adhesive composition has a glass transition temperature of the entire composition (i.e., the first glass transition temperature Tg₁) of −80° C. to 10° C. inclusive. The first glass transition temperature Tg₁ is preferably −70° C. or higher, more preferably −60° C. or higher, still more preferably −40° C. or higher. Also, the first glass transition temperature Tg₁ is preferably 0° C. or lower, more preferably −10° C. or lower, still more preferably -20° C. or lower. The first glass transition temperature Tg₁ is preferably −70° C. to 0° C. inclusive, more preferably −60° C. to 0° C. inclusive, still more preferably −60° C. to −10° C. inclusive, particularly preferably −60° C. to −20° C. inclusive. When the first glass transition temperature Tg₁ is lower than −80° C., the formed adhesive layer has insufficient cohesive force, thereby possibly impairing tensile shear bonding strength or other properties, whereas when the first Tg₁ is higher than 10° C., tackiness, adhesion at low temperature or the like may be insufficient. Notably, the Tg of the present adhesive composition (i.e., the first glass transition temperature Tg₁) has been determined through DSC at a temperature elevation rate of 10° C./min in an nitrogen atmosphere.

The present adhesive composition may be produced through modifying the first glass transition temperature Tg₁ and the below-mentioned Tg of the surface portion of the adhesive layer (i.e., the second glass transition temperature Tg₂). In other words, those skilled in the art can produce the present adhesive composition by appropriately selecting the members of the vinyl polymer (A), the acrylic adhesive polymer (B), and other ingredients according to the disclosure of the present specification. Specifically, the first glass transition temperature Tg₁, the second glass transition temperature Tg₂, and the difference between two Tgs are controlled to specific values of interest, in order to realize adhesion of the finally produced adhesive layer and softness of the bonding portion.

The adhesive composition of the present disclosure is used for forming an adhesive layer on a separator serving as a substrate. The adhesive layer is formed through a procedure of, for example, applying the adhesive composition onto a separator through a known application method, and preferably removing the solvent through drying via heating or another means. Notably, so long as the solvent can be removed, the temperature and time of heating for forming the adhesive layer may be appropriately predetermined in accordance with the solvent, solid content, etc. of the adhesive composition.

When the present adhesive composition is used to form an adhesive layer, the layer has a storage elastic modulus of 1.0 MPa or less at 23° C. (hereinafter may be referred to as a “storage elastic modulus G′”). Through controlling the storage elastic modulus G′ to 1.0 MPa or less, a fabric remains soft during hot pressing, even though the fabric has been impregnated with resin through the mesh thereof. In addition, fiber fabrics can be bonded together at high bonding strength. From the viewpoint of enhancing softness and feeling of the bonding portion, the storage elastic modulus G′ (23° C.) is preferably 0.70 MPa or less, more preferably 0.5 MPa or less, still more preferably 0.4 MPa or less, yet more preferably 0.3 MPa or less. No particular limitation is imposed on the lower limit of the storage elastic modulus G′ (23° C.), and the value is, for example, 0.01 MPa or more.

In the present specification, the storage elastic modulus G′ is determined by measuring the shear viscoelastic modulus of adhesive layer (thickness 0.8 mm) under the following measuring conditions: temperature of measurement of 23° C., temperature elevation rate of 2° C./min, strain of 0.1%, and measurement frequency of 1 Hz. The storage elastic modulus G′ may be arbitrarily adjusted by modifying the composition and cross-linking degree of the acrylic adhesive polymer (B) and the amount of the plasticizer added. In particular, the storage elastic modulus G′ is preferably adjusted by using a (meth)acrylate ester compound having a C1 to C4 alkyl group or alkoxyalkyl group, serving as a monomer forming the acrylic adhesive polymer (B).

### [Tg of the Surface Portion of the Adhesive Layer (Second Glass Transition Temperature Tg₂)]

The second glass transition temperature Tg₂ is calculated from the compositional ratio of the surface portion of the adhesive layer formed from the present adhesive composition. More specifically, the Tg of the surface portion of the adhesive layer is calculated from the compositional ratio of the surface portion, where the compositional ratio is determined through X-ray photoelectron spectroscopy of the adhesive layer which has been formed by applying the present adhesive composition onto a separator and drying the applied composition. Through X-ray photoelectron spectroscopy (XPS), the compositional ratio of the vinyl polymer (A) to the acrylic adhesive polymer (B) is calculated. The Tg₂ is regarded as the glass transition temperature of a surface portion of the adhesive layer ranging from the air interface to a depth of about 5 nm. The specific steps of measurement may be carried out through the procedure described in the below-mentioned Examples.

No particular limitation is imposed on the second glass transition temperature Tg₂, but it is preferably 0° C. or higher. A second glass transition temperature Tg₂ of 0° C. or higher facilitates obtaining of the below-described temperature difference ΔTg. As a result, high-temperature bonding and durability of bonding objects can be secured. The second glass transition temperature Tg₂ is more preferably 6.8° C. or higher, still more preferably 10° C. or higher, yet more preferably 25° C. or higher, further more preferably 40° C. or higher. No particular limitation is imposed on the upper limit of the second glass transition temperature Tg₂, and it is, for example, 100° C. or lower. The second glass transition temperature Tg₂ can be appropriately modified by the glass transition temperature Tg_{A} of the vinyl polymer (A), the mixing ratio, the glass transition temperature Tg_{B} of the acrylic adhesive polymer (B), and other parameters.

[Temperature Difference ΔTg Between the First Glass Transition Temperature Tg₁ and the Second Glass Transition Temperature Tg₂]

In the present adhesive composition, the second glass transition temperature Tg₂ is preferably higher than the first glass transition temperature Tg₁ by 30° C. or more. The adhesive layer having such a Tg composition can provide high peel strength and tensile shear bonding strength. Meanwhile, the adhesion of the adhesive layer formed from a conventional adhesive composition lowers, as the temperature rises. However, the present adhesive composition can exhibit high adhesion (peel strength to a bonding object) at high temperature.

The second glass transition temperature Tg₂ is higher than the first glass transition temperature Tg₁ preferably by 40° C. or more, more preferably by 50° C. or more, still more preferably by 60° C. or more, yet more preferably by 65° C. or more, further more preferably by 70° C. or more. No particular limitation is imposed on the upper limit of the difference between the second glass transition temperature Tg₂ and the first glass transition temperature Tg₁. In consideration of the allowable values of the first glass transition temperature Tg₁ and the second glass transition temperature Tg₂, the temperature difference is preferably 230° C. or less, generally 200° C. or less.

### [Mass Fraction of Vinyl Polymer (A) to the Total Mass of Vinyl Polymer (A) and Acrylic Adhesive Polymer (B) Present in the Surface Portion of the Adhesive Layer (W_{A}=A/A+B)]

Through X-ray photoelectron spectroscopy for composition analysis of the surface portion of the adhesive layer formed from the present adhesive composition, the mass fraction of the vinyl polymer (A) in the surface portion can be determined. More specifically, the mass fraction (W_{A}) of vinyl polymer (A) to the total mass of vinyl polymer (A) and acrylic adhesive polymer (B) can be determined. The mass fraction (W_{A}) can be employed as an index for the segregation state of the vinyl polymer (A) in the surface portion of the present adhesive layer.

For example, the mass fraction W_{A} (represented by %) is preferably 55% to 95% inclusive. When the mass fraction falls within the range, segregation of the vinyl polymer (A) in the surface portion can be confirmed. In this case, high adhesion and durability can be also attained under high-temperature and -moisture conditions. The mass fraction W_{A} (represented by %) is more preferably 60% or higher, still more preferably 65% or higher, yet more preferably 70% or higher, further more preferably 75% or higher, further more preferably 80% or higher. Also, the mass fraction W_{A} is preferably 90% or lower, more preferably 85% or lower.

The mass fraction (W_{B}=B/A+B) (represented by %) of the acrylic adhesive polymer (B) in the surface portion which has been determined through X-ray photoelectron spectroscopy for composition analysis of the surface portion of the adhesive layer formed from the present adhesive composition is preferably 5% to 45% inclusive. The mass fraction W_{B} is more preferably 10% or higher, still more preferably 15% or higher. Also, the mass fraction W_{B} is more preferably 40% or lower, still more preferably 30% or lower, yet more preferably 35% or lower, further more preferably 20% or lower. The mass ratio ((A)/(B)) of the vinyl polymer (A) to the acrylic adhesive polymer (B) in the surface portion, which has been determined through X-ray photoelectron spectroscopy for the composition analysis of the surface portion of the adhesive layer formed from the present adhesive composition, is preferably 55/45 to 95/5, more preferably 60/40 to 90/10, still more preferably 70/30 to 85/15.

Notably, the segregation behavior of the vinyl polymer (A) in the adhesive layer surface during formation of the adhesive layer from the adhesive composition of the present disclosure is based on the fact that the vinyl polymer (A) and the acrylic adhesive polymer (B) are not completely compatible and cause no complete phase separation. In one or more embodiments, the vinyl polymer (A) is less polar than the acrylic adhesive polymer (B). The adhesive composition of the present disclosure preferably contains a vinyl polymer (A) which is not completely compatible with the acrylic adhesive polymer (B).

Segregation of the vinyl polymer (A) occurs during formation of the adhesive layer, and the vinyl polymer (A) is segregated on the surface side where the solvent evaporates (i.e., air interface side). Thus, in the adhesive layer (sheet or film) formed from the present adhesive composition, when the two surface layers opposing along the thickness direction are in contact with a substance having a low surface energy (e.g., gas or a particular solid), the low-surface-energy interface side which is in contact with the above substance contains the vinyl polymer (A) at higher concentration. At the center along the thickness direction of the adhesive layer, the vinyl polymer (A) concentration is lower. That is, there can be obtained an adhesive layer having such a graded composition that the vinyl polymer (A) concentration is higher at the surface layer of the adhesive layer. In contrast, from the viewpoint of the acrylic adhesive polymer (B), the obtained adhesive layer has such a graded composition that the acrylic adhesive polymer (B) concentration is lower at the surface layer of the adhesive layer.

Notably, for example, in the adhesive layer (sheet or film) formed from the present adhesive composition, when only one of the two surface layers opposing along the thickness direction serves as a low-surface-energy interface side, the vinyl polymer (A) is contained at higher concentration on the interface side of the resultant adhesive layer.

The present adhesive composition presents a segregation of the vinyl polymer (A) in an adhesive layer, leading to the following. That is, the Tg calculated from the composition of the surface portion obtained through X-ray photoelectron spectroscopy of the adhesive layer (i.e., second glass transition temperature Tg₂) can be made to be higher than the Tg of the adhesive composition (i.e., first glass transition temperature Tg₁)by 30° C. or more. As a result, the adhesion property of the adhesive layer can be regulated, to thereby attain favorable bonding strength. In other words, the Tg in the vicinity of the bonding interface defined by the surface of the adhesive layer is relatively high, whereby a favorable adhesion which has not conventionally been attained can be realized. Even when a fiber fabric is used as a bonding object, high peel strength and tensile shear bonding strength can be attained. For example, even when tensile stress is applied to the bonding portion, or an article of clothing or the like is repeatedly used, the bonding portion is resistant to peeling, thereby attaining favorable durability. Also, the adhesive composition of the present disclosure can impart high bonding strength to difficult-to-bond fiber fabrics which have received a special treatment (e.g., waterproofing). Thus, the present adhesive composition can be considerably suitable for bonding fiber fabrics and the like for use in clothes and the like.

### [Adhesive Sheet]

In one mode, the adhesive layer of the adhesive sheet can be formed by applying the present adhesive composition to a substrate such as a separator and removing the solvent via heat-drying. That is, the adhesive layer of the thus-formed adhesive sheet can be endowed with the composition originating from the present adhesive composition, the first glass transition temperature Tg₁, and the storage elastic modulus G′. The adhesive sheet having an adhesive layer formed from the adhesive composition can provide good peeling strength and excellent tensile shear bonding strength. Also, through bonding fiber fabrics by the mediation of the sheet, the softness and texture of the bonding site can be enhanced.

Alternatively, the adhesive sheet may be a substrate-free sheet in which the adhesive layer is sandwiched by two separators having different peel strengths. Yet alternatively, one of the fiber fabrics to be bonded may serve as a substrate. No particular limitation is imposed on the shape of the adhesive sheet, and the shape may be appropriately selected in accordance with use thereof. The adhesive sheet may be in a leaf form or a roll form. Alternatively, the adhesive sheet may be in a strip form, and may have any shape so as to fit to the bonding site of an article of clothing.

The thickness of the adhesive layer of the adhesive sheet may be appropriately set in accordance with the type of the fiber fabrics to be bonded, the area and form of the bonding site, etc. The thickness of the adhesive layer is generally 1 μm or greater and may be 5 μm or greater, 10 μm or greater, or 20 μm or greater. The upper limit of the thickness is generally 500 μm and may be 300 μm or less, 200 μm or less, or 100 μm or less. In order to tune the thickness of the adhesive layer of the adhesive sheet to a value of interest, a plurality of adhesive layers may be stacked, to thereby form the combined adhesive layer of the adhesive sheet.

The adhesive composition and the adhesive sheet of the present disclosure may be widely used as an adhesive for bonding fiber fabrics and other purposes. No particular limitation is imposed on the fiber fabrics bonded by means of the adhesive composition and the adhesive sheet of the present disclosure. Examples of the fiber fabric include textile, knitted fabric, nonwoven fabric, lacework, leather articles (e.g., natural leather, synthetic leather, and artificial leather), and furs. Since the adhesive composition of the present disclosure can form an adhesive layer which can maintain the softness and texture of fabrics of various types of fiber and provide high stickiness, the composition can be suitably used particularly for fiber fabrics for clothes. No particular limitation is imposed on the material of the fiber fabrics, and there may be appropriately used synthetic fibers of polyester, polyamide, acrylic fiber, etc.; regenerated fibers such as rayon and cupra; semi-synthetic fibers such as acetate fiber; and natural fibers such as cotton, hemp, and wool. The surfaces of the fiber fabrics to be bonded may be subjected to waterproof treatment or the like.

### [Clothes]

The article of clothing of the present disclosure includes a bonding portion where fiber fabrics are bonded together by the mediation of the adhesive layer formed from the adhesive composition of the present disclosure for bonding fiber fabrics. Thus, the article of clothing of the present disclosure has excellent durability. That is, even in the case where tensile stress is applied to the bonding portion, or the article of clothing is repeatedly used, the bonding portion is still resistant to peeling. Also, the adhesive layer obtained from the present adhesive composition has sufficient softness under conditions such as wearing of the cloth. Therefore, the bonding portion is prevented from stiffening and the like, and the cloth provides an excellent texture.

The present article of clothing is produced via a step of bonding fiber fabrics by the mediation of an adhesive sheet having an adhesive layer formed from the present adhesive composition. In bonding the fiber fabrics, the relevant fiber fabrics are placed so that the fiber fabrics are in contact with each other by the mediation of the adhesive sheet. Subsequently, the resultant stacked body may be subjected to heat pressing or a similar technique. In heat press bonding, the pressure of bonding may be appropriately adjusted so as to attain a target bonding strength. The heating temperature is preferably adjusted to a temperature lower than the temperature at which the fiber fabrics remain without issue.

When the present adhesive composition is employed, fabric bonding portions remain soft during a heat bonding process such as hot pressing or iron pressing, even when the fabrics have been impregnated with resin through the mesh thereof. In addition, fiber fabrics can be bonded together at high bonding strength. Thus, the present adhesive composition can be suitably used particularly as a tackifier for use in, for example, production of a wide variety of clothes including everyday clothes (Western and Japanese), ethnic clothes, innerwear (e.g., seamless lingerie articles or inner articles), outerwear, tops, bottoms, outdoor goods, working clothes, uniforms, dress suits, swimsuits, sportswear, socks and stockings, caps and hats, and shoes, or in handicraft working.

### EXAMPLES

Specific embodiments of the disclosure of the present specification will next be described. However, the disclosure of the present specification should not be limited by the specific examples. As used herein, the units “part” and “%” denote “parts by mass” and “mass %,” respectively.

The various measurements of the present specification were obtained through the below-described analytical methods.

### <Solid Content>

A measurement sample (about 1 g) was weighed (a) and dried at 155° C. for 30 minutes by means of an air-blow drier. Then, the weight of the residue was weighed (b). The solid content was calculated by the following formula. Each sample was weighed by use of a weighing bottle. Other operations were in accordance with JIS K 0067-1992 (Test methods for loss and residue of chemical products).

Solid content (%)=(b/a)×100

### <Molecular Weight Measurement>

Molecular weights (Mw and Mn) were determined through GPC under the following conditions.
GPC: TOSOH (HLC-8120)
Column: TOSOH (TSKgel-Super MP-M×4)
Sample concentration: 0.1%
Flow rate: 0.6 mL/min
Eluent: tetrahydrofuran
Column temperature: 40° C.
Detector: differential refractometer (RI)
Standard substance: polystyrene

### <Glass Transition Temperature (Tg)>

The glass transition temperature of the vinyl polymer (A) Tg_{A}, the glass transition temperature of the acrylic adhesive polymer (B) Tg_{B}, and the glass transition temperature of the adhesive composition Tg₁ were measured through DSC under the following conditions.
DSC: TA Instrument (Q-100)
Temperature elevation rate: 10° C./min
Measurement atmosphere: nitrogen

### <Polymer Composition>

The compositional ratio of a polymer (i.e., polymer composition) was calculated from the amount of fed monomer(s) and the amount of consumed monomer(s) as measured through gas chromatography (GC).
GC: Agilent Technologies (7820A GC System)
Detector: FID
Column: 100% dimethylsiloxane (CP-Sil 5CB), length of 30 m, inner diameter of 0.32 mm
Calculation: internal standard

### 1. Synthesis of Vinyl Polymers

### Synthetic Example 1

### Synthesis of polymer A-1

To a four-neck flask (volume capacity: 1 L), a liquid mixture of butyl acetate (210 parts by mass) and dimethyl-2,2′-azobis(2-methylpropionate) (V-601, product of Wako Pure Chemical Industries, Ltd.) (0.9 parts by mass) was added, and the liquid mixture was sufficiently degassed through bubbling with nitrogen. The liquid mixture was heated to 90° C. Separately, another liquid mixture containing methyl methacrylate (hereinafter may be abbreviated as “MMA”) (165 parts by mass), isobornyl methacrylate (hereinafter may be abbreviated as “IBXMA”) (44 parts by mass), V-601 (17 parts by mass), and butyl acetate (90 parts by mass) was added dropwise to the flask via a dropping funnel over 5 hours, to thereby conduct polymerization. After termination of the dropwise addition, the resultant solution was added dropwise to hexane (6,000 parts by mass), to thereby isolate a vinyl polymer from the resultant liquid. Thus, polymer A-1 was yielded. The polymer composition of the thus-obtained polymer A-1 was calculated from the amount of fed monomers and the amount of consumed monomers as determined through GC. As a result, the polymer was found to have a polymer composition: MMA 80 mass % and IBXMA 20 mass %, with Mw of 7,390, Mn of 4,760, and Mw/Mn of 1.55. The Tg of the polymer was 100° C. Table 1 shows the composition and analytical results of polymer A-1.

### Synthetic Example 2

### Synthesis of Polymer A-2

To a four-neck flask (volume capacity: 1 L), a liquid mixture of butyl acetate (200 parts by mass) and V-601 (4.0 parts by mass) was added, and the liquid mixture was sufficiently degassed through bubbling with nitrogen. The liquid mixture was heated to 90° C. Separately, another liquid mixture containing MMA (59 parts by mass), IBXMA (200 parts by mass), V-601 (75 parts by mass), and butyl acetate (90 parts by mass) was added dropwise to the flask via a dropping funnel over 5 hours, to thereby conduct polymerization. After termination of the dropwise addition, the resultant solution was added dropwise to a mixture of methanol (2,800 parts by mass) and distilled water (700 parts by mass), to thereby isolate a vinyl polymer from the resultant liquid. Thus, polymer A-2 was yielded. Table 1 shows the composition and analytical results of polymer A-2.

### Synthetic Example 3

### Synthesis of Polymer A-3

To a four-neck flask (volume capacity: 1 L), a liquid mixture containing MMA (19 parts by mass), styrene (hereinafter may be abbreviated as “St”) (11 parts by mass), butyl acetate (224 parts by mass), and V-601 (8.7 parts by mass) was added, and the liquid mixture was sufficiently degassed through bubbling with nitrogen. The liquid mixture was heated to 90° C. Separately, another liquid mixture containing MMA (108 parts by mass), St (93 parts by mass), V-601 (78 parts by mass), and butyl acetate (90 parts by mass) was added dropwise to the flask via a dropping funnel over 5 hours, to thereby conduct polymerization. After termination of the dropwise addition, the resultant solution was added dropwise to a mixture of methanol (4,200 parts by mass) and distilled water (1,800 parts by mass), to thereby isolate a vinyl polymer from the resultant liquid. Thus, polymer A-3 was yielded. Table 1 shows the composition and analytical results of polymer A-3.

### Synthetic Example 4

### Synthesis of Polymer A-4

To a four-neck flask (volume capacity: 1 L), a liquid mixture of butyl acetate (221 parts by mass) and V-601 (3.2 parts by mass) was added, and the liquid mixture was sufficiently degassed through bubbling with nitrogen. The liquid mixture was heated to 90° C. Separately, another liquid mixture containing MMA (34 parts by mass), n-butyl methacrylate (hereinafter may be abbreviated as “BMA”) (215 parts by mass), V-601 (60 parts by mass), and butyl acetate (90 parts by mass) was added dropwise to the flask via a dropping funnel over 5 hours, to thereby conduct polymerization. After termination of the dropwise addition, a mixture of methanol (4,200 parts by mass) and distilled water (1,800 parts by mass), to thereby isolate a vinyl polymer from the resultant liquid. Thus, polymer A-4 was yielded. Table 1 shows the composition and analytical results of polymer A-4.

TABLE 1

| | | Composition (mass %) | | | | | | Mw/ | Tg |
|---|---|---|---|---|---|---|---|---|---|
| | | MMA | IEXMA | St | BMA | Mn | Mw | Mn | (° C.) |
| Vinyl | Polymer | 80 | 20 | | | 4,760 | 7,390 | 1.55 | 100 |
| poly- | A-1 | | | | | | | | |
| mer | Polymer | 30 | 70 | | | 1,420 | 2,120 | 1.49 | 65 |
| | A-2 | | | | | | | | |
| | Polymer | 60 | | 40 | | 1,540 | 2,260 | 1.47 | 44 |
| | A-3 | | | | | | | | |
| | Polymer | 20 | | | 80 | 1,910 | 2,570 | 1.35 | 27 |
| | A-4 | | | | | | | | |

### 2. Synthesis of Acrylic Adhesive Polymers (B)

### Synthetic Example 5

### Synthesis of Polymer B-1

To a four-neck flask (volume capacity: 2 L), a liquid mixture containing 2-methoxyethyl acrylate (hereinafter may be abbreviated as “MEA”) (255 parts by mass), n-butyl acrylate (hereinafter may be abbreviated as “BA”) (30 parts by mass), 2-hydroxyethyl acrylate (hereinafter may be abbreviated as “HEA”) (15 parts by mass), and ethyl acetate (520 parts by mass) was added, and the liquid mixture was sufficiently degassed through bubbling with nitrogen. The liquid mixture was heated to 40° C., and 2,2′-azobis(2,4-dimethylvaleronitrile) (V-65, product of Wako Pure Chemical Industries, Ltd.) (11.4 parts by mass) was added to the mixture, to thereby initiate polymerization. Four hours after the start of polymerization, the resultant solution was added dropwise to hexane (10,000 parts by mass), to thereby isolate an acrylic adhesive polymer from the resultant liquid. Thus, polymer B-1 was yielded. The Thus-obtained polymer B-1 was found to have a polymer composition: MEA 85 mass %, BA 10 mass %, and HEA 5 mass %, with Mw of 520,000, Mn of 80,000, and Mw/Mn of 6.5. The Tg of the polymer was −35° C. Table 2 shows the composition and analytical results of polymer B-1.

### Synthetic Example 6

### Synthesis of Polymer B-2

To a four-neck flask (volume capacity: 2 L), a liquid mixture containing MEA (188 parts by mass), BA (192 parts by mass), HEA (20 parts by mass), and ethyl acetate (740 parts by mass) was added, and the liquid mixture was sufficiently degassed through bubbling with nitrogen. The liquid mixture was heated to 40° C., and V-65 (10.3 parts by mass) was added to the mixture, to thereby initiate polymerization. Four hours after the start of polymerization, the resultant solution was added dropwise to hexane (10,000 parts by mass), to thereby isolate an acrylic adhesive polymer from the resultant liquid. Thus, polymer B-2 was yielded. Table 2 shows the composition and analytical results of polymer B-2.

### Synthetic Example 7

### Synthesis of Polymer B-3

To a four-neck flask (volume capacity: 2 L), a liquid mixture containing methyl acrylate (hereinafter may be referred to as “MA”) (240 parts by mass), BA (140 parts by mass), HEA (20 parts by mass), and ethyl acetate (740 parts by mass) was added, and the liquid mixture was sufficiently degassed through bubbling with nitrogen. The liquid mixture was heated to 40° C., and V-65 (10.3 parts by mass) was added to the mixture, to thereby initiate polymerization. Four hours after the start of polymerization, the resultant solution was added dropwise to hexane (10,000 parts by mass), to thereby isolate an acrylic adhesive polymer from the resultant liquid. Thus, polymer B-3 was yielded. Table 2 shows the composition and analytical results of polymer B-3.

TABLE 2

| | | Composition | | | | | | | |
|---|---|---|---|---|---|---|---|---|---|
| | | (mass %) | | | | | | Mw/ | Tg |
| | | MEA | MA | BA | HEA | Mn | Mw | Mn | (°C.) |
| Acrylic | Poly- | 85 | | 10 | 5 | 80,000 | 520,000 | 6.5 | −35 |
| ad- | mer | | | | | | | | |
| hesive | B-1 | | | | | | | | |
| poly- | Poly- | 47 | | 48 | 5 | 90,000 | 510,000 | 5.7 | −38 |
| mer | mer | | | | | | | | |
| (B) | B-2 | | | | | | | | |
| | Poly- | | 60 | 35 | 5 | 149,000 | 568,000 | 3.8 | −7 |
| | mer | | | | | | | | |
| | B-3 | | | | | | | | |

3. Production and evaluation of adhesive composition

### Example 1

The polymer A-1 produced in Synthetic Example 1 was dissolved in ethyl acetate, to thereby prepare a solution of polymer A-1 having a solid content of 30 mass %. In the same manner, the polymer B-1 produced in Synthetic Example 5 was dissolved in ethyl acetate, to thereby prepare a solution of polymer B-1 having a solid content of 30 mass %. The prepared polymer A-1 solution (8 parts by mass), the prepared polymer B-1 solution (100 parts by mass), and Takenate D-110N (solid content: 75 mass %, product of Mitsui Chemicals, Inc.) serving as a cross-linking agent (0.16 parts by mass) were mixed together, to thereby yield an adhesive composition. The thus-obtained adhesive composition was found to have a Tg (a first glass transition temperature Tg₁)of −28.4° C.

The adhesive composition was applied onto a separator (thickness: 38 μm) made of polyethylene terephthalate (PET) such that the thickness of the adhesive layer was adjusted to 50 μm after drying. The adhesive composition was dried at 80° C. for 4 minutes, to thereby remove ethyl acetate and induce cross-linking reaction. Subsequently, another PET separator (thickness: 38 μm) having a different peel strength was attached to the adhesive composition, and the stacked body was allowed to stand at 40° C. for 5 days for aging, to thereby produce an adhesive sheet sample sandwiched with separators. The thus-obtained adhesive sheet sample was subjected to various measurements and evaluation through the below-mentioned methods. Table 3 shows the obtained results.

### <Gel Fraction Ratio Acrylic Adhesive Polymer (B)>

A portion of adhesive (0.2 g) was sampled from the adhesive layer of the adhesive sheet sample, and the adhesive sample was weighed to determine initial mass. Subsequently, the adhesive sample was immersed in ethyl acetate (50 g), and the mixture was allowed to stand at room temperature for 16 hours. Then, the immersion mixture was filtered through a 200-mesh metal wire netting, and the residue remaining on the mesh was dried at 80° C. for 3 hours. The dried residue was weighed to obtain mass thereof. From the initial mass and the mass of the dried residue, the gel fraction ratio of the acrylic adhesive polymer (B) was calculated by the following formula:

Gel fraction ratio (%)=(mass of residue after drying)/[(initial mass)×(solid content of acrylic adhesive polymer (B) in adhesive composition)/(solid content of entire adhesive composition)]×100

### <T-Peel Strength>

Two sheets of nylon fabric which had been waterproofed were bonded to each other by the mediation of an adhesive sheet sample (cut piece having a width of 2.5 cm), to thereby prepare a stacked body having a structure of nylon fabric/adhesive sheet/nylon fabric. The stacked body was hot-pressed by means of a “Precision hot-press CYP-T” (product of Sintokogio, Ltd.) at 130° C. and 3 kg/cm² for 10 seconds, to thereby press-bond the component layers. The thus-pressed stacked body was employed as a test piece, and the peel strength of the sample toward the direction perpendicular to the adhesion surface was measured by means of a tensile tester with a thermostat bath, INSTRON 5566A (product of Instron Japan), under the following conditions: measurement temperature of 23° C., test piece width of 2.5 cm, and peeling speed of 300 mm/min.

### <Tensile Shear Bonding Strength>

A nylon fabric which had been waterproofed was cut into two cut pieces having a width of 2.5 cm, and the pieces were bonded to each other by the mediation of an adhesive sheet sample such that the two pieces overlapped for a width of 1 cm. In the same manner as employed in the aforementioned peel strength measurement, the two pieces were hot-pressed (i.e., at 130° C. and 3 kg/cm² for 10 seconds), to thereby press-bond the bonded product. The peel strength of the pressed product was measured toward the shear direction by means of a tensile tester with a thermostat bath, INSTRON 5566A (product of Instron Japan), under the following conditions: measurement temperature of 23° C., test piece width of 2.5 cm, and peeling speed of 300 mm/min.

### <Storage Elastic Modulus at 23° C.>

The aforementioned adhesive sheet samples were stacked, to thereby prepare samples of the adhesive layer each having a thickness of 800 μm. The resultant stacked sheet was punched out to provide disk samples each having a diameter of 1 cm, and the samples were subjected to kinematic viscoelasticity analysis by means of a viscoelastic meter Physica MCR301 (product of Anton Paar), while the sample was heated at a temperature elevation rate of 2° C./min from −50° C. to 150° C. The kinematic viscoelasticity was determined at a strain of 0.1% and a frequency of 1 Hz. The storage elastic modulus G′ at 23° C. was monitored. Notably, a parallel plate having a diameter of 8 mm was used as a sample.

### <Touch Feeling Test: Texture>

The texture was evaluated by bending hardness of the bonding portion formed through hot pressing.

O: soft

X: feels stiffness

### <Tg of Surface Portion of Adhesive Layer>

The mass fractions of the vinyl polymer (A) (W_{A}) and the acrylic adhesive polymer (B) (W_{B}) with respect to the total amount of the vinyl polymer (A) and the acrylic adhesive polymer (B) in the surface portion of the adhesive layer were calculated from a peak area ratio of O1s to C1s obtained through X-ray photoelectron spectrometry (XPS) of each adhesive sheet sample. According to the FOX equation, the Tg₂ of the surface portion was calculated.

Notably, XPS was conducted under the following conditions.
Apparatus: PHI5000 VersaProbe (product of ULVAC-PHI, Inc.)
X-ray: Al-Kα (1486.6 eV)
X-ray incident angle: 0° (angle to the line normal to the observation surface of the sample)
Photoelectron detection angle: 45° (angle to the line normal to the observation surface of the sample)

Specifically, the above mass fraction was calculated through the following method.

As shown in the following formula (1), the peak area ratio of O1s to C1s obtained through XPS is represented by the ratio of the number of oxygen atoms present in a unit mass of the surface portion of the adhesive layer formed from the adhesive composition to the number of carbon atoms present in the same.

$$\begin{matrix}[ F 1 ] & \\ {( \frac{O}{C} )}_{A + B} = \frac{\frac{( 1 - {w}_{A} )}{{M}_{w - B}} \times {N}_{O - B} + \frac{{w}_{A}}{{M}_{w - A}} \times {N}_{O - A}}{\frac{( 1 - {w}_{A} )}{{M}_{w - B}} \times {N}_{C - B} + \frac{{w}_{A}}{{M}_{w - A}} \times {N}_{C - A}} & ( 1 )\end{matrix}$$

(in the formula (1),
(O/C)_{A+B}: a peak area ratio of O1s to C1s obtained through XPS of the adhesive layer formed by applying the adhesive composition onto a separator and drying;
W_{A}: a mass fraction of the vinyl polymer (A) to the total amount of the vinyl polymer (A) and the acrylic adhesive polymer (B);
M_{W-A}: a weight average molecular weight of the entire monomer units forming the vinyl polymer (A);
M_{W-B}: a weight average molecular weight of the entire monomer units forming the acrylic adhesive polymer (B);
N_{O-A}: a value of the number of oxygen atoms contained in the mean monomer structural formula of the entire monomers forming the vinyl polymer (A);
N_{O-B}: a value of the number of oxygen atoms contained in the mean monomer structural formula of the entire monomers forming the acrylic adhesive polymer (B);
N_{C-A}: a value of the number of carbon atoms contained in the mean monomer structural formula of the entire monomers forming the vinyl polymer (A); and
N_{C-B}: a value of the number of carbon atoms contained in the mean monomer structural formula of the entire monomers forming the acrylic adhesive polymer (B))

Also, the peak area ratio of O1s to C1s in a film of the vinyl polymer (A) obtained through XPS is represented by formula (2) and the peak area ratio of O1s to C1s in a film of the acrylic adhesive polymer (B) obtained through XPS is represented by formula (3), wherein the film is formed by applying a monomer or monomers of the relevant polymer onto a separator and drying.

$$\begin{matrix}[ F 2 ] & \\ {( \frac{O}{C} )}_{A} = \frac{{N}_{O - A}}{{N}_{C - A}} & ( 2 )\end{matrix}$$

(in formula (2), (O/C)_{A}: a peak area ratio of O1s to C1s in a film formed by drying the vinyl polymer (A) obtained through XPS).

$$\begin{matrix}[ F 3 ] & \\ {( \frac{O}{C} )}_{B} = \frac{{N}_{O - B}}{{N}_{C - B}} & ( 3 )\end{matrix}$$

(in formula (3), (O/C)_{B}: a peak area ratio of O1s to C1s in a film formed by drying the acrylic adhesive polymer (B) obtained through XPS)

From the above formulas (1) to (3), the below formula (4) is derived. The mass fraction of the vinyl polymer (A) (W_{A}) to the total amount of the vinyl polymer (A) and the acrylic adhesive polymer (B) is calculated from formula (4).

$$\begin{matrix} [ F 4 ] & \\ {( \frac{O}{C} )}_{A + B} = \frac{\frac{( 1 - {w}_{A} )}{{M}_{w - B}} \times {N}_{C - B} \times {( \frac{O}{C} )}_{B} \times + \frac{{w}_{A}}{{M}_{w - A}} \times {N}_{C - A} \times {( \frac{O}{C} )}_{A}}{\frac{( 1 - {w}_{A} )}{{M}_{w - B}} \times {N}_{C - B} + \frac{{w}_{A}}{{M}_{w - A}} \times {N}_{C - A}} & ( 4 )\end{matrix}$$

Further, from the above-obtained W_{A} value and the below formula (5), the mass fraction of the acrylic adhesive polymer (B) (W_{B}) is calculated.

[F5]

W_{B}=1−W_{A} (5)

(in formula (5), W_{B}: a mass fraction of the acrylic adhesive polymer (B) to the total amount of the vinyl polymer (A) and the acrylic adhesive polymer (B))

In Example 1, specific elements of formula (4) are as follows.
(O/C)_{A+B}: 0.327 (measured value)
(O/C)_{A}: 0.309 (measured value)
(O/C)_{B}: 0.435 (measured value)
N_{C-A}: from the number of carbon atoms of 1 molecule of MMA (5), the number of carbon atoms of 1 molecule of IBXMA (14), and the compositional ratio, 5×89.9 (mol %)+14×10.1(mol %)=5.91
N_{C-B}: from the number of carbon atoms of 1 molecule of MEA (6), the number of carbon atoms of 1 molecule of BA (7), the number of carbon atoms of 1 molecule of HEA (5), and the compositional proportions, 6×84.4 (mol %)+7×10.1 (mol %)+5×5.6 (mol %)=6.05
M_{W-A}: from the molecular weight of MMA (100), the molecular weight of IBXMA (222), and the compositional ratio, 100×89.9 (mol %)+222×10.1 (mol %)=112.3
M_{W-B}: the molecular weight of MEA (130), the molecular weight of BA (128), the molecular weight of HEA (116), and the compositional proportions, 130×84.4 (mol %)+128×10.1 (mol %)+116×5.6 (mol %)=129.0

Thus, W_{A}=0.840 was obtained by inputting these values to formula (4), and W_{B}=0.160 was obtained by inputting these values to formula (5).

Next, according to the FOX's equation represented by the below formula (6), by inputting the surface composition obtained through XPS, the Tg of the surface portion (the second glass transition temperature Tg₂) was calculated to 69.0° C.

1/[Tg₂](K)=W_{A}/Tg_{A}+W_{B}/Tg_{B} (6)

(in formula (6), Tg_{A}: Tg of the vinyl polymer (A) (100° C. in the case of polymer A-1) and Tg_{B}: Tg of the acrylic adhesive polymer (B) (−35° C. in the case of polymer B-1))

### Examples 2 to 4 and Comparative Examples 1 and 2

The procedure of Example 1 was repeated, except that the types of the vinyl polymer (A) and the acrylic adhesive polymer (B) and the feed proportions were modified as shown in Table 3, to thereby produce adhesive compositions. In addition, the same measurement as performed in Example 1 was also conducted. Table 3 shows the results.

### Comparative Examples 3 and 4

By use of a commercial urethane-based hot-melt adhesive, an adhesive sheet sample in which an adhesive layer (50 μm) was sandwiched by separators was yielded. The urethane-based hot-melt adhesives used in Comparative Examples 3 and 4 were different commercial products. In addition, the same measurement as performed in Example 1 was also conducted. Table 3 shows the results.

In Table 3, regarding the vinyl polymer (A) and the acrylic adhesive polymer, each of the values of the ingredients of the adhesive composition represents an amount thereof in the form of a polymer solution having a solid content of 30 mass %. Regarding the cross-linking agent, each of the values represents an amount thereof in the form of an agent having a solid content of 75 mass %. For example, in Example 1, the vinyl polymer (A) and the acrylic adhesive polymer (B) were used at a mass ratio of 8:100 (as solid content). Tg₁ of Comparative Examples 3 and 4 denotes a glass transition temperature of a urethane-based hot-melt adhesive. In addition, since the glass transition temperature of the surface portion of the adhesive layer was not calculated in Comparative Examples 3 and 4, the symbol “−” was put in the cells corresponding to Tg₂ and ΔTg.

TABLE 3

| | | | | Example | Example | Example | Example | Comparative | Comparative | Comparative | Comparative |
|---|---|---|---|---|---|---|---|---|---|---|---|
| | | | | 1 | 2 | 3 | 4 | Example 1 | Example 2 | Example 3 | Example 4 |
| Adhesive | Compo- | Vinyl | A-1 | 8 | | | 6 | | | | |
| compo- | sition | polymer | A-2 | | 6 | | | | | | |
| sition | (parts by | | A-3 | | | 10 | | | | | |
| | mass) | | A-4 | | | | | | 10 | | |
| | | Acrylic | B-1 | 100 | | 100 | | | 100 | | |
| | | adhesive | B-2 | | 100 | | | 100 | | | |
| | | polymer | B-3 | | | | 100 | | | | |
| | | (B) | | | | | | | | | |
| | | Cross- | Takenate | 0.16 | 0.16 | 0.16 | 0.16 | 0.16 | 0.16 | — | — |
| | | linking | D-110N | | | | | | | | |
| | | agent | | | | | | | | | |

| Urethane-based hot-melt adhesive | | | | | | | | 100 | 100 |
|---|---|---|---|---|---|---|---|---|---|
| Evaluation | Gel fraction ratio (%) | 78.0 | 75.0 | 73.5 | 73.5 | 74.8 | 75.5 | — | — |
| | Mass ratio ((A)/(B)) in | 84/16 | 55/45 | 60/40 | 78/22 | 0/100 | 58/42 | — | — |
| | surface portion | | | | | | | | |
| | determined through XPS | | | | | | | | |
| | (I) Tg of surface portion | 69.0 | 9.3 | 6.8 | 69.7 | −35.0 | −2.6 | — | — |
| | (Tg₂) (° C.) | | | | | | | | |
| | (II) Tg of adhesive | −28.4 | −33.9 | −29.5 | −2.6 | −35.0 | −30.4 | −7.0 | −20.0 |
| | composition (Tg₁) (° C.) | | | | | | | | |
| | (I) - (II) ΔTg = TG₂ − Tg₁ (° C.) | 97.4 | 43.2 | 36.3 | 72.3 | 0.0 | 27.9 | — | — |
| | T-peel strength (N/25 mm) | 10.7 | 8.3 | 7.5 | 8.5 | 4.3 | 5.0 | 5.6 | 4.1 |
| | Tensile shear bending | 119.7 | 108.6 | 97.5 | 110.3 | 68.0 | 79.8 | 142.2 | 103.5 |
| | strength (N) | | | | | | | | |
| | Storage elastic modules | 0.13 | 0.12 | 0.12 | 0.51 | 0.12 | 0.12 | 1.98 | 2.46 |
| | at 23° C. (MPa) | | | | | | | | |
| | Texture | ∘ | ∘ | ∘ | ∘ | ∘ | ∘ | x | x |

As is clear from Table 3, Examples 1 to 4 employing the adhesive composition disclosed in the present specification all exhibited a second glass transition temperature Tg₂ which was higher than the corresponding first glass transition temperature Tg₁ by 30° C. or more. Also, in Examples 1 to 4, high peel strength and tensile shear bonding strength were also attained with respect to a waterproofed nylon fabric, which is resistant to adhesion. Furthermore, Examples 1 to 4 provided a bonding portion having softness and excellent texture. In particular, Examples 1 and 2, employing vinyl polymer A-1 or A-2 formed from a structural unit originating from an alicyclic vinyl monomer, exhibited a low storage elastic modulus of the adhesive layer (at 23° C.) of 0.13 or lower and a high peel strength and a high tensile shear bonding strength. Also, Examples 1 to 3, employing polymer B-1 or polymer B-2 mainly formed from 2-methoxyethyl acrylate (MEA) and n-butyl acrylate (BA) as the acrylic adhesive polymer, exhibited a storage elastic modulus of the adhesive layer (at 23° C.) lower than that of Example 4, employing polymer B-3 mainly formed from methyl acrylate (MA).

In contrast, in Comparative Example 1, employing no vinyl polymer (A), and in Comparative Example 2, exhibiting a low glass transition temperature Tg_{A} (27° C.) of the vinyl polymer (A), the peel strength and tensile shear bonding strength were poor. In addition, the bonding strength of the bonded fiber fabrics was insufficient, as compared with Examples 1 to 4. In Comparative Examples 3 and 4, employing a urethane-based hot-melt adhesive, the storage elastic modulus values of the adhesive layer (at 23° C.) were as high as 1.98 and 2.48, respectively, and the texture was unsatisfactory.

Although the disclosure has been described with respect to only a limited number of embodiments, those skilled in the art, having benefit of this disclosure, will appreciate that various other embodiments may be devised without departing from the scope of the present invention. Accordingly, the scope of the invention should be limited only by the attached claims.

1. An adhesive composition for bonding fiber fabrics, the adhesive composition comprising:
a vinyl polymer (A); and
an acrylic adhesive polymer (B), wherein
the vinyl polymer (A) has a glass transition temperature Tg_{A} of 30° C. to 200° C. inclusive and a number average molecular weight of 500 to 10,000 inclusive,
the adhesive composition has a glass transition temperature Tg₁ of −80° C. to 10° C. inclusive, and an adhesive layer formed from the adhesive composition exhibits a storage elastic modulus of 1.0 MPa or less at 23° C.

2. The adhesive composition according to claim 1, wherein
a surface portion of the adhesive layer has a glass transition temperature Tg₂ that is higher, by 30° C. or more, than the glass transition temperature Tg₁ of the adhesive composition,
the adhesive layer is formed on a separator using the adhesive composition, and
the glass transition temperature Tg₂ is calculated from composition of the surface portion of the adhesive layer through X-ray photoelectron spectroscopy.

3. The adhesive composition according to claim 1, wherein the vinyl polymer (A) has structural units derived from an alicyclic vinyl monomer in an amount of 10 mass % or more, with respect to the total monomer units forming the vinyl polymer (A).

4. The adhesive composition according to claim 1, wherein the amount of the vinyl polymer (A) is 0.5 parts by mass to 60 parts by mass inclusive, with respect to 100 parts by mass of the acrylic adhesive polymer (B).

5. An adhesive sheet comprising:
a separator; and
an adhesive layer formed on the separator using the adhesive composition according to claim 1.

6. An article of clothing, comprising:
a bonding portion where fiber fabrics are bonded to each other through an adhesive layer formed using the adhesive composition according to claim 1.

7. The adhesive composition according to claim 1, wherein the acrylic adhesive polymer (B) has a structural unit derived from an alkyl (meth)acrylate having a C4 to C12 alkyl group.

8. The adhesive composition according to claim 1, wherein the acrylic adhesive polymer (B) has a structural unit derived from an alkoxyalkyl (meth)acrylate having a C2 to C12 alkoxyalkyl group.

9. The adhesive composition according to claim 8, wherein the acrylic adhesive polymer (B) has structural units derived from the alkoxyalkyl (meth)acrylate in an amount of 30 mass % or more, with respect to the total monomer units forming the acrylic adhesive polymer (B).

10. The adhesive composition according to claim 1, wherein the acrylic adhesive polymer (B) has a number average molecular weight of 30,000 to 500,000.

11. The adhesive composition according to claim 1, further comprising:
a cross-linking agent.
